(19) United States
(12) Patent Application Publication
(10) Pub. No.: US 2006/0133695 A1
(43) Pub. Date: Jun. 22, 2006

(54) Display controller, electronic instrument, and image data supply method

(75) Inventor: Atsushi Obinata, Hachiouji (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/305,475

(22) Filed: Dec. 16, 2005

(30) Foreign Application Priority Data
Dec. 20, 2004 (JP) 2004-367412

(51) Int. Cl. G06K 9/32

(52) U.S. Cl. 382/296

(57) ABSTRACT

A display controller includes: an image memory; a first rotation processing section which performs processing of writing image data after first rotation processing into the image memory, the first rotation processing causing a vertical direction of an image of the image data to rotate by a first rotation angle; a second rotation processing section which performs processing of reading the image data after second rotation processing from the image memory, the second rotation processing causing a vertical direction of an image of the image data stored in the image memory to rotate by a second rotation angle; and a compression processing section which performs compression processing of the image data. The display controller supplies the image data read from the image memory to the display driver without performing the second rotation processing, and supplies the image data after the second rotation processing to the compression processing section.

Japanese Patent Application No. 2004-367412, filed on Dec. 20, 2004, is hereby incorporated by reference in its entirety.

### BACKGROUND OF THE INVENTION

The present invention relates to a display controller, an electronic instrument, and an image data supply method.

In recent years, a display panel represented by a liquid crystal display (LCD) panel has been generally provided in a portable instrument (electronic instrument in a broad sense) such as a portable telephone. The display panel is driven by a display driver based on image data. The image data may be image data captured by a camera module or image data generated or processed by a host, for example. The display driver receives the image data and a display synchronization signal, and controls drive of the display panel.

A display controller supplies the image data and the display synchronization signal instead of the host to reduce processing load imposed on the host. The display controller may be provided with an image memory as a frame memory in order to reduce power consumption.

JP-A-10-210349 discloses technology of performing rotation correction by changing a read-order address from a buffer memory based on rotation information calculated from detection results for the vertical position of a camera, and writing the image data after rotation correction into an image memory.

It may be necessary to cause the vertical direction (orientation) of a display image to differ from the vertical direction of a compression processing image. However, according to the technology disclosed in JP-A-10-210349, the vertical direction of the compression processing image must be aligned with the vertical direction of the display image. For example, when imaging a person by using a camera and transmitting the image data in a compressed state, a situation may occur on the receiver side in which the head and the foot of the person are reversed in the decompressed image. Therefore, the technology disclosed in JP-A-10-210349 requires an additional sequence of changing the rotation angle of the display image and the rotation angle of the compression processing image.

In recent years, the amount of image data for one frame has been increased accompanying an increase in display size of the display panel. Therefore, a high-capacity dynamic random access memory (DRAM) may be used as an image memory. The DRAM has a shorter access time per specific number of bytes of data in a sequential access operation than in a random access operation. Therefore, when accessing the image data after rotation processing, the random access operation is repeatedly performed due to discontinuity of the access address. This increases the number of accesses, whereby power consumption is increased.

In view of the above-described situation, it is desirable that the vertical direction of the display image and the vertical direction of the compression processing image be independently rotated at low power consumption.

### SUMMARY

According to a first aspect of the invention, there is provided a display controller which supplies image data to a display driver which drives a display panel, the display controller comprising:

an image memory for storing image data;

a first rotation processing section which performs processing of writing the image data after first rotation processing into the image memory, the first rotation processing causing a vertical direction of an image of the image data to be supplied to the display driver to rotate by a first rotation angle;

a second rotation processing section which performs processing of reading the image data after second rotation processing from the image memory, the second rotation processing causing a vertical direction of an image of the image data stored in the image memory to rotate by a second rotation angle; and

a compression processing section which performs compression processing of the image data stored in the image memory,

wherein the image data read from the image memory by a sequential access operation is supplied to the display driver without performing the second rotation processing for the image data stored in the image memory, and the image data read from the image memory by the second rotation processing section is supplied to the compression processing section.

According to a second aspect of the invention, there is provided an electronic instrument, comprising:

a display panel;

the above-described display controller; and

a display driver which drives the display panel based on image data supplied from the display controller.

According to a third aspect of the invention, there is provided an image data supply method of supplying image data to a display driver which drives a display panel, the method comprising:

writing the image data after first rotation processing into an image memory, the first rotation processing causing a vertical direction of an image of the image data to be supplied to the display driver to rotate by a first rotation angle; and

performing compression processing of the image data after second rotation processing which causes a vertical direction of an image of the image data read from the image memory to rotate by a second rotation angle, and supplying the image data read from the image memory by a sequential access operation to the display driver without performing the second rotation processing for the image data stored in the image memory.

### BRIEF DESCRIPTION OF THE SEVERAL VIEWS OF THE DRAWING

FIG. 1 is a configuration example of a display system to which a display controller according to one embodiment of the invention is applied.

FIG. 2 is a block diagram of a configuration example of the display controller shown in FIG. 1.

FIG. 3 is schematic illustrative of rotation processing of the display controller.

FIG. 4 is schematic illustrative of rotation processing of the display controller.

FIG. 5 is illustrative of rotation angles of first and second rotation processing sections according to one embodiment of the invention.

FIGS. 6A to 6D are illustrative of an installation angle of a camera module.

FIGS. 7A to 7D are illustrative of an installation angle of a display panel.

FIG. 8 is a block diagram of a configuration example of a display controller in a comparative example of one embodiment of the invention.

FIG. 9 is illustrative of the difference in sequence between one embodiment of the invention and the comparative example.

FIG. 10 shows an example of a sequence of a display controller in the comparative example when implementing an operation shown in FIG. 9.

FIG. 11 shows an example of a sequence of a display controller according to one embodiment of the invention when implementing an operation shown in FIG. 9.

FIGS. 12A and 12B are schematic illustrative of a display frame and a compression processing frame in the comparative example and one embodiment of the invention.

FIG. 13 is illustrative of control information used for write address generation processing of a first rotation processing section.

FIGS. 14A to 14D are illustrative of a setting example of a write start address and an offset address corresponding to a first rotation angle.

FIG. 15 shows an operation flow of the first rotation processing section.

FIG. 16 shows an operation flow of the first rotation processing section.

FIG. 17 shows the relationship among an installation angle of a camera module, an installation angle of a display panel, a first rotation angle, and a second rotation angle according to one embodiment of the invention.

FIG. 18 is a block diagram of a detailed hardware configuration example of a display controller according to one embodiment of the invention.

FIG. 19 is a block diagram of a configuration example of a control register shown in FIG. 18.

FIG. 20 is a timing diagram of an operation example of the display controller shown in FIG. 18.

FIG. 21 is a block diagram of a configuration example of an electronic instrument to which the display controller according to one embodiment of the invention is applied.

### DETAILED DESCRIPTION OF THE EMBODIMENT

The invention may provide a display controller, an electronic instrument, and an image data supply method capable of independently rotating the vertical direction of a display image and the vertical direction of a compression processing image at low power consumption.

According to one embodiment of the invention, there is provided a display controller which supplies image data to a display driver which drives a display panel, the display controller comprising:

an image memory for storing image data;

a first rotation processing section which performs processing of writing the image data after first rotation processing into the image memory, the first rotation processing causing a vertical direction of an image of the image data to be supplied to the display driver to rotate by a first rotation angle;

a second rotation processing section which performs processing of reading the image data after second rotation processing from the image memory, the second rotation processing causing a vertical direction of an image of the image data stored in the image memory to rotate by a second rotation angle; and

a compression processing section which performs compression processing of the image data stored in the image memory,

wherein the image data read from the image memory by a sequential access operation is supplied to the display driver without performing the second rotation processing for the image data stored in the image memory, and the image data read from the image memory by the second rotation processing section is supplied to the compression processing section.

In this embodiment, the first rotation processing section is provided on the write side of the image memory which stores the image data, the second rotation processing section is provided on the read side of the image memory, and the first and second rotation processing sections perform the rotation processing using the rotation angles independently set.

The image data read from the image memory by the sequential access operation is supplied to the display driver without performing the second rotation processing of the image data stored in the image memory. The image data read from the image memory by the second rotation processing section is supplied to the compression processing section.

Therefore, the periodically repeated read processing of the image data into the display driver can be realized by the sequential access operation, so that the number of accesses to the image memory can be reduced in comparison with the random access operation. This significantly reduces power consumption accompanying access to the image memory.

Moreover, the vertical direction of the image of the image data output to the display driver can be caused to differ from the vertical direction of the image of the image data subjected to the compression processing by the compression processing section. This prevents occurrence of a situation in which the vertical direction of the image of the image data subjected to the compression processing is determined depending on the vertical direction of the image of the image data before the first rotation processing and the vertical direction of the image of the image data displayed in the display panel.

This display controller may further comprise:

a line buffer which retains at least part of the image data,

wherein the image data is retained in the line buffer and the first rotation processing is performed by using the retained image data when performing the processing of writing the image data into the image memory; and

wherein the image data read from the image memory by the sequential access operation is retained in the line buffer and the second rotation processing is performed by using the retained image data when performing the processing of reading the image data from the image memory.

In this embodiment, since the line buffer is used by the first and second rotation processing sections, the configuration of the display controller can be simplified and cost of the display controller can be reduced. In particular, it is unnecessary to provide two line buffers when the write processing and the read processing for the image memory are not performed at the same time, so that cost of the display controller can be reduced.

In this display controller,

the number of frames in which the processing of writing the image data for one frame into the image memory is performed within a unit time may be smaller than the number of frames in which the processing of reading the image data for one frame from the image memory is performed within the unit time.

In this embodiment, since the read processing from the image memory performed at a high rate is realized by the sequential access operation, a significant increase in speed and a reduction in power consumption of the read processing from the image memory can be achieved.

In this display controller,

the processing of writing the image data into the image memory may be given priority over the processing of reading the image data from the image memory.

In this embodiment, occurrence of a situation in which the image data before being written into the image memory is lost due to a delay of the processing of writing the image data into the image memory can be prevented.

This display controller may further comprise:

an input image interface for inputting the image data before the first rotation processing; and

a display driver interface for outputting the image data read from the image memory to the display driver.

In this display controller,

the first rotation angle may be set based on an installation angle of an imaging section which captures the image data before the first rotation processing, and an installation angle of the display panel.

In this display controller,

when causing the vertical direction of an image of the image data before the first rotation processing to rotate by a rotation angle Ca with respect to a predetermined orientation in a predetermined rotation direction and causing the vertical direction of an image of the image data supplied to the display driver to rotate by a rotation angle La with respect to a predetermined orientation in a predetermined rotation direction, the first rotation angle may be (La−Ca)°.

In this embodiment, when the vertical direction of the image of the image data before the first rotation processing and the vertical direction of the image of the image data supplied to the display driver have been determined, the first rotation angle can be specified by using a simple configuration. As a result, a display controller which can arbitrarily set the vertical direction of the image subjected to the compression processing independent of the vertical direction of the image of the image data before the first rotation processing and the vertical direction of the image of the image data supplied to the display driver can be provided at low cost and low power consumption.

In this display controller,

when the first rotation angle is Wa° (0≦Wa<360), the second rotation angle may be (360−Wa)°.

In this embodiment, the second rotation angle can be specified by using a simple configuration. As a result, a display controller which can arbitrarily set the vertical direction of the image subjected to the compression processing independent of the vertical direction of the image of the image data before the first rotation processing and the vertical direction of the image of the image data supplied to the display driver can be provided at low cost and low power consumption.

According to one embodiment of the invention, there is provided an electronic instrument, comprising:

a display panel;

the above-described display controller; and

a display driver which drives the display panel based on image data supplied from the display controller.

This electronic instrument may further comprise:

a host which performs output and input of the image data to and from the display controller.

In this embodiment, an electronic instrument including a display controller capable of independently rotating the vertical direction of a display image and the vertical direction of a compression processing image at low power consumption can be provided.

According to one embodiment of the invention, there is provided an image data supply method of supplying image data to a display driver which drives a display panel, the method comprising:

writing the image data after first rotation processing into an image memory, the first rotation processing causing a vertical direction of an image of the image data to be supplied to the display driver to rotate by a first rotation angle; and

performing compression processing of the image data after second rotation processing which causes a vertical direction of an image of the image data read from the image memory to rotate by a second rotation angle, and supplying the image data read from the image memory by a sequential access operation to the display driver without performing the second rotation processing for the image data stored in the image memory.

In this image data supply method,

the number of frames in which the processing of writing the image data for one frame into the image memory is performed within a unit time may be smaller than the number of frames in which the processing of reading the image data for one frame from the image memory is performed within the unit time.

In this image data supply method,

the processing of writing the image data into the image memory may be given priority over the processing of reading the image data from the image memory.

In this image data supply method,

when causing the vertical direction of an image of the image data before the first rotation processing to rotate by a rotation angle Ca with respect to a predetermined orientation in a predetermined rotation direction and causing the vertical direction of an image of the image data supplied to the display driver to rotate by a rotation angle La with respect to a predetermined orientation in a predetermined rotation direction, the first rotation angle may be (La−Ca)°.

In this image data supply method, when the first rotation angle is Wa° (0≦Wa<360), the second rotation angle may be (360−Wa)°.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Display System

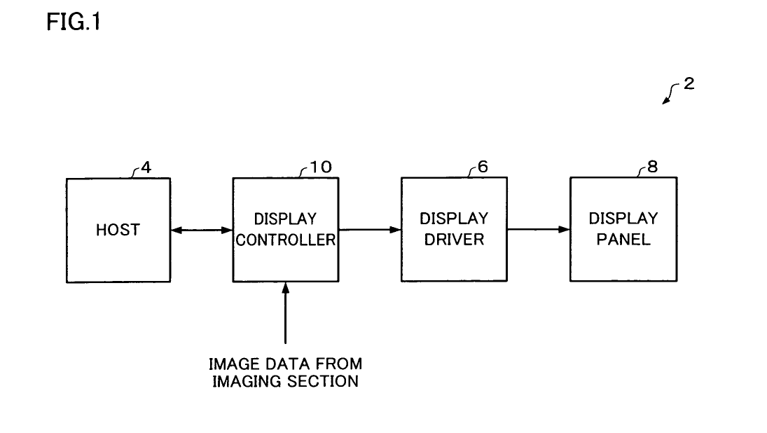

FIG. 1 shows a configuration example of a display system to which a display controller according to one embodiment of the invention is applied. The display system shown in FIG. 1 is provided in an electronic instrument, for example. The display system may be considered to be an electronic instrument in a broad sense.

A display system 2 includes a host 4, a display controller 10, a display driver 6, and a display panel 8 (display section in a broad sense). The host 4 includes a central processing unit (CPU) and a memory, and realizes a predetermined function by allowing the CPU to read a program stored in the memory and execute processing corresponding to the program. The host 4 generates or processes image data corresponding to an image to be displayed in the display panel 8, and supplies the image data to the display controller 10.

The display controller 10 supplies the image data from the host 4 or image data obtained by processing the image data from the host 4 to the display driver 6 which drives the display panel 8.

The display driver 6 drives the display panel 8 based on the image data from the display controller 10. As the display panel 8, an active matrix type or simple matrix type LCD panel may be used, for example.

The display controller 10 is provided between the host 4 and the display driver 6 and processes the image data instead of the host 4 so that processing load imposed on the host 4 can be reduced, for example.

The display controller 10 may receive image data from an imaging section (not shown), and the host 4 may process the image data. In this case, the imaging section generates an image.

2. Display Controller

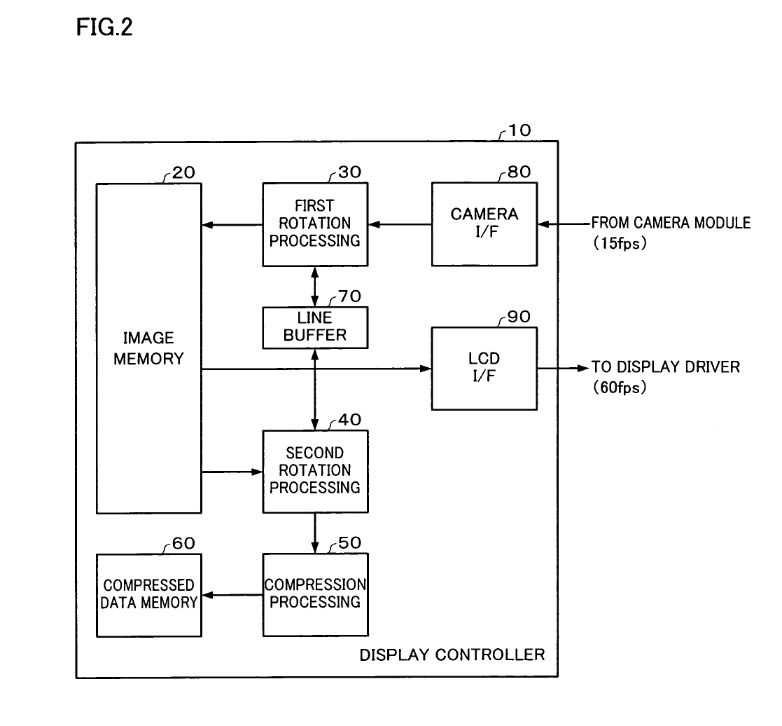

FIG. 2 is a block diagram of a configuration example of the display controller shown in FIG. 1.

The display controller 10 according to one embodiment of the invention supplies image data to the display driver 6 which drives the display panel 8 (LCD panel). The display controller 10 includes an image memory 20, first and second rotation processing sections 30 and 40, and a compression processing section 50. After the image data is stored in the image memory 20, the image data is directly supplied to the display driver 6 and is also subjected to compression processing while rotating the vertical direction of the image expressed by the image data.

The image memory 20 stores the image data. The function of the image memory 20 may be realized by a DRAM or a static random access memory (SRAM). The DRAM has a shorter access time per specific number of bytes (specific unit) of data in the sequential access operation than in the random access operation. The DRAM allows high-speed access to consecutive pieces of data by an access operation generally called a high-speed column access operation. The high-speed column access operation may be realized by designating consecutive column addresses while designating a fixed row address. The high-speed column access operation may be called a sequential access operation in a broad sense. The DRAM exhibits higher efficiency in the sequential access operation than in the random access operation.

In the case where the function of the image memory 20 is realized by using an SRAM and the data bus width of the SRAM is 128 bits, when reading 16-bit image data for one pixel, the remaining 112-bit (=128−16) data is discarded. When writing 16-bit image data for one pixel, masking is necessary. Therefore, the sequential access operation results in an inefficient access. On the other hand, image data for eight pixels can be accessed by the sequential access operation so that the SRAM can be efficiently accessed.

The first rotation processing section 30 is provided on the write side of the image memory 20. The first rotation processing section 30 performs processing of writing the image data after first rotation processing into the image memory 20. The first rotation processing is processing of causing the vertical direction (orientation) of the image of the image data to be supplied to the display driver 6 to rotate by a first rotation angle (write rotation angle). In more detail, the first rotation processing may be referred to as processing of generating image data of an image obtained by causing the vertical direction of the image expressed by the image data to rotate clockwise by the first rotation angle around a given reference point, for example. The function of the first rotation processing section 30 may be realized by a circuit which generates the write address which specifies the write region of the image memory 20. The first rotation processing section 30 writes the image data into the image memory 20 by the random access operation or the sequential access operation depending on the size of the first rotation angle.

The second rotation processing section 40 performs processing of reading the image data after second rotation processing from the image memory 20. The second rotation processing is processing of causing the vertical direction of the image of the image data stored in the image memory 20 to rotate by a second rotation angle (compression processing read rotation angle). In more detail, the second rotation processing may be referred to as processing of generating image data of an image obtained by causing the vertical direction of the image expressed by the image data to rotate clockwise by the second rotation angle around a given reference point, for example. The function of the second rotation processing section 40 may be realized by a circuit which generates a read address which specifies the read region of the image memory 20. The second rotation processing section 40 reads the image data from the image memory 20 by the random access operation or the sequential access operation depending on the size of the second rotation angle.

The compression processing section 50 performs compression processing of the image data read by the second rotation processing section 40. The compression processing section 50 performs compression processing according to the Joint Photographic Coding Experts Group (JPEG) standard, for example. The compressed data compressed by the compression processing section 50 is written into a compressed data memory 60 provided in the display controller 10. The compressed data written into the compressed data memory 60 is read by the host 4.

The display controller 10 supplies the image data read from the image memory 20 by the sequential access operation to the display driver 6 without performing the second rotation processing for the image data stored in the image memory 20. Specifically, the display controller 10 reads the image data stored in the image memory 20 by the sequential access operation and supplies the image data to the display driver 6 without rotating the vertical direction of the image expressed by the image data.

The display controller 10 may include a line buffer 70. The line buffer 70 retains at least a piece of image data. When performing the processing of writing the image data into the image memory 20, the first rotation processing section 30 retains the image data in the line buffer 70 and performs the first rotation processing by using the retained image data. When performing the processing of reading the image data from the image memory 20, the second rotation processing section 40 retains the image data read from the image memory by the sequential access operation in the line buffer 70 and performs the second rotation processing by using the retained image data. The configuration of the display controller 10 can be simplified and cost of the display controller 10 can be reduced by allowing the first and second rotation processing 10 sections 30 and 40 to use the line buffer 70 when the write processing and the read processing for the image memory 20 are not performed at the same time.

The display controller 10 may include a camera interface (I/F) circuit 80 as an input image interface and an LCD I/F circuit 90 as a display driver interface.

The image data before the first rotation processing is input to the camera I/F circuit 80 from a camera module (not shown). The camera module supplies the image data of the captured image to the display controller 10 at a rate of 15 frames per second (fps), for example. The camera I/F circuit 80 performs image data input interface processing (processing of receiving image data from the camera module or signal buffering), and outputs the image data after the interface processing to the first rotation processing section 30 and the image memory 20. The camera I/F circuit 80 outputs a synchronization clock signal to the camera module, and receives the image data of the image captured by the camera module in synchronization with the synchronization clock signal, for example.

The LCD I/F circuit 90 outputs the image data read from the image memory 20 to the display driver 6. The LCD I/F circuit 90 supplies the image data to the display driver 6 at a rate of 60 fps, for example. The LCD I/F circuit 90 performs image data interface processing (processing of transmitting image data to the display driver 6 or signal buffering), and outputs the image data after the interface processing to the display driver 6. The LCD J/F circuit 90 includes a synchronization signal generation circuit (not shown). The LCD I/F circuit 90 generates a synchronization signal (e.g. vertical synchronization signal VSYNC, horizontal synchronization signal HSYNC, and dot clock signal DCK) for driving the display panel 8, and supplies the synchronization signal to the display driver 6.

As described above, the display controller 10 includes the first rotation processing section 30 provided on the write side of the image memory 20 and the second rotation processing section 40 provided on the read side of the image memory 20. The first and second rotation processing sections 30 and 40 perform the rotation processing using the rotation angles independently set. This enables the image data to be supplied to the display driver 6 at low power consumption. Moreover, the vertical direction of the image of the image data output to the display driver 6 can be caused to differ from the vertical direction of the image of the image data subjected to the 15 compression processing by the compression processing section 50.

2.1 Rotation Processing

The rotation processing of the display controller is described below. The following description is given on the assumption that the rotation angle of the rotation processing is 0°, 90°, 180°, or 270°. However, the invention is not limited thereto. The following description is given taking an example of using a charge coupled device (CCD) image sensor module including a CCD image sensor as the camera module. However, the camera module may be a CMOS image sensor module including a CMOS image sensor.

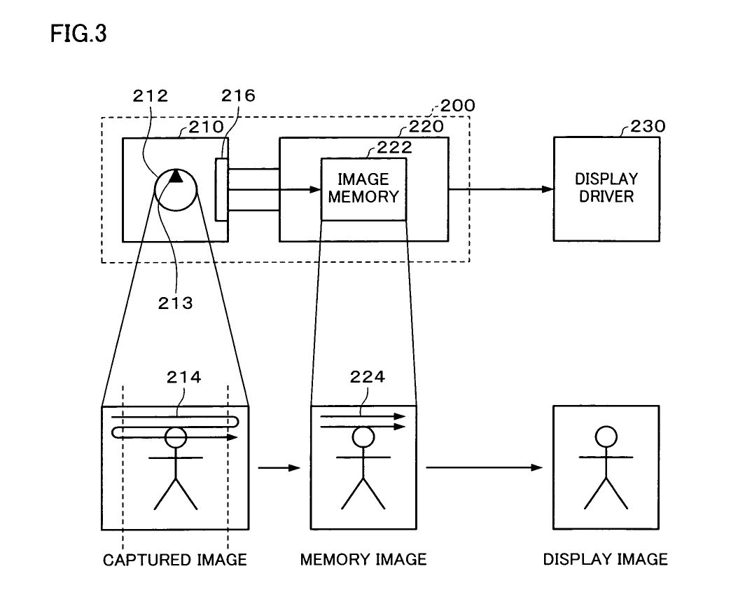

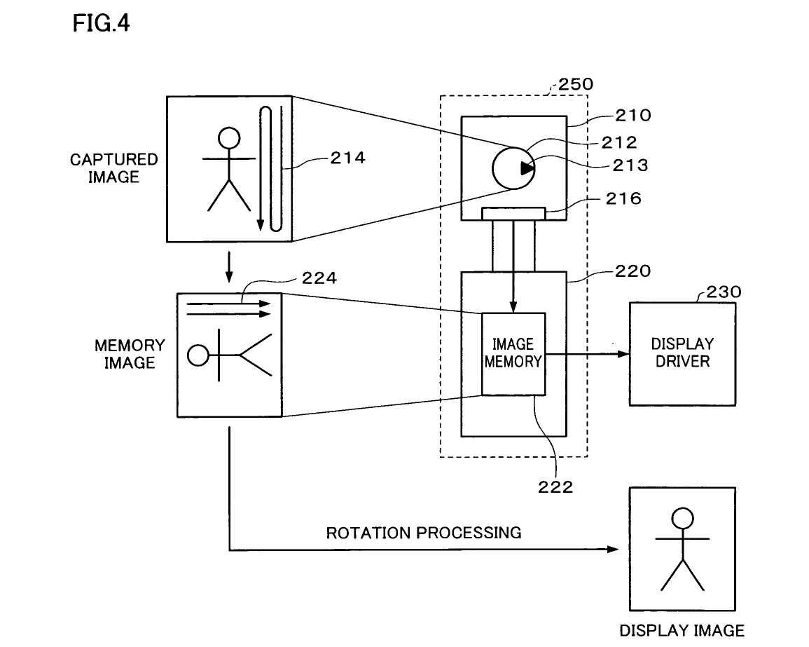

FIGS. 3 and 4 are schematic illustrative of the rotation processing of the display controller. In FIGS. 3 and 4, identical sections are indicated by the identical symbols. Description of these sections is appropriately omitted.

As shown in FIG. 3, a mounting region 200 is provided for a camera module and a display controller. A CCD image sensor module 210 (camera module in a broad sense) and a display controller 220 (or display module including the display controller) are disposed in the mounting region 200. The CCD image sensor module 210 includes a CCD image sensor 212. The CCD image sensor 212 outputs data of the captured image for one frame (for one screen) by generating an electric charge corresponding to the amount of light incident on two-dimensionally arranged CCDs and reading the generated electric charge.

The CCD image sensor module 210 sequentially outputs data for each pixel (dot) of the image captured by the CCD image sensor 212 in the order of a scan direction 214. The scan direction 214 of the CCD image sensor 212 is fixed, and the position of a data output section 216 of the CCD image sensor module 210 is also fixed. In FIGS. 3 and 4, a mark 213 is provided on the CCD image sensor 212. The vertical direction (vertical position) of the CCD image sensor 212 is determined by the position of the mark 213. The scan direction and the scan order of the CCD image sensor 212 are thus determined. For example, the scan direction 214 is determined by the position of the mark 213 shown in FIG. 3.

In FIG. 3, the image data input in the order corresponding to the scan direction 214 is input to the display controller 220. The display controller 220 writes the input image data into the image memory 222 in the order of a write direction 224. The arrangement of each storage region of the image memory 222 corresponds to the arrangement of each pixel of the display panel. Therefore, the display driver 230 which drives the display panel can display an image having a vertical direction the same as the vertical direction of the image captured by the CCD image sensor 212 as shown in FIG. 3, by allowing the display controller 220 to read the image data from the storage region of the image memory 222 in a predetermined order and supply the image data to the display driver 230.

Consider the case where the mounting region is changed to a mounting region 250 shown in FIG. 4 without changing the vertical direction of the image displayed in the display panel. Since the CCD image sensor 212 rotates clockwise by 90°, the scan direction 214 also rotates clockwise by 90° with respect to the captured image.

On the other hand, since the write direction 224 of the image memory 222 is fixed, data of an image having the vertical direction shown in FIG. 4 is written into the image memory 222. As a result, the memory image of the image memory 222 rotates counterclockwise by 90°. If the display controller 220 reads the image data stored in each storage region of the image memory 222 in the same order as shown in FIG. 3 and supplies the read image data to the display driver 230, the image is displayed in the display panel in the vertical direction of the memory image shown in FIG. 4. Therefore, it is necessary to perform the rotation processing of rotating the vertical direction of the image of the image data on the write side or the read side of the image memory 222 and supply the processed data to the display driver 230.

According to one embodiment of the invention, the display controller includes the first and second rotation processing sections 30 and 40 which independently perform the rotation processing on the write side and the read side of the image memory 20. The first and second rotation processing sections 30 and 40 cause the vertical direction of the image to rotate by different rotation angles corresponding to the combination of the installation angle of the camera module and the installation angle of the display panel. The display controller directly outputs the image data read from the image memory to the display driver without performing the rotation processing, and performs the compression processing of the image data while appropriately rotating the vertical direction of the image from the image memory.

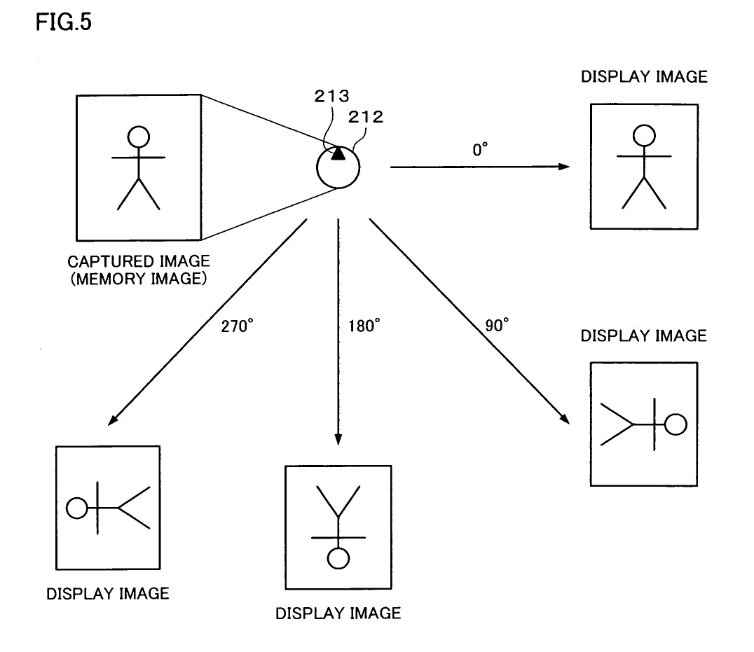

FIG. 5 is illustrative of the rotation angles of the first and second rotation processing sections 30 and 40 according to one embodiment of the invention.

In FIG. 5, the rotation angle is determined based on a reference direction in which the vertical direction of the image of the object captured by the CCD image sensor 212 (vertical direction of the captured image) coincides with the vertical direction of the object. In this case, the vertical direction of the captured image coincides with the vertical direction of the image of the image data retained in the image memory (vertical direction of the memory image).

The rotation angle when the vertical direction of the image displayed in the display panel (vertical direction of the display image) coincides with the vertical direction of the memory image is defined as 0°. The rotation angle when the vertical direction of the display image coincides with the vertical direction of the memory image rotated clockwise 90° around the center point of the memory image is defined as 90° (=−270°), for example. The rotation angle when the vertical direction of the display image coincides with the vertical direction of the memory image rotated clockwise 180° around the center point of the memory image is defined as 180° (=−180°), for example. The rotation angle when the vertical direction of the display image coincides with the vertical direction of the memory image rotated clockwise 270° around the center point of the memory image is defined as 270° (=−90°), for example.

The first rotation angle of the first rotation processing section 30 is a rotation angle which causes the vertical direction of the image of the image data to be written into the image memory 20 to coincide with the vertical direction of the image displayed in the display panel. Therefore, the first rotation angle is determined corresponding to the installation angle of the camera module and the installation angle of the display panel. The installation angle of the camera module used herein refers to the installation angle of the CCD image sensor 212 of the CCD image sensor module 210.

Since the image data read from the image memory 20 can be directly output to the display driver without performing the rotation processing, the image memory 20 can be accessed by the sequential access operation.

The second rotation angle of the second rotation processing section 40 is a rotation angle which causes the vertical direction of the image of the image data subjected to the rotation processing by the first rotation processing section 30 to coincide with the vertical direction of the object. Specifically, the second rotation angle is an angle which causes the vertical direction of the image subjected to the first rotation processing by the first rotation processing section 30 to be returned to the original vertical direction. Therefore, the second rotation angle is also determined corresponding to the installation angle of the camera module and the installation angle of the display panel.

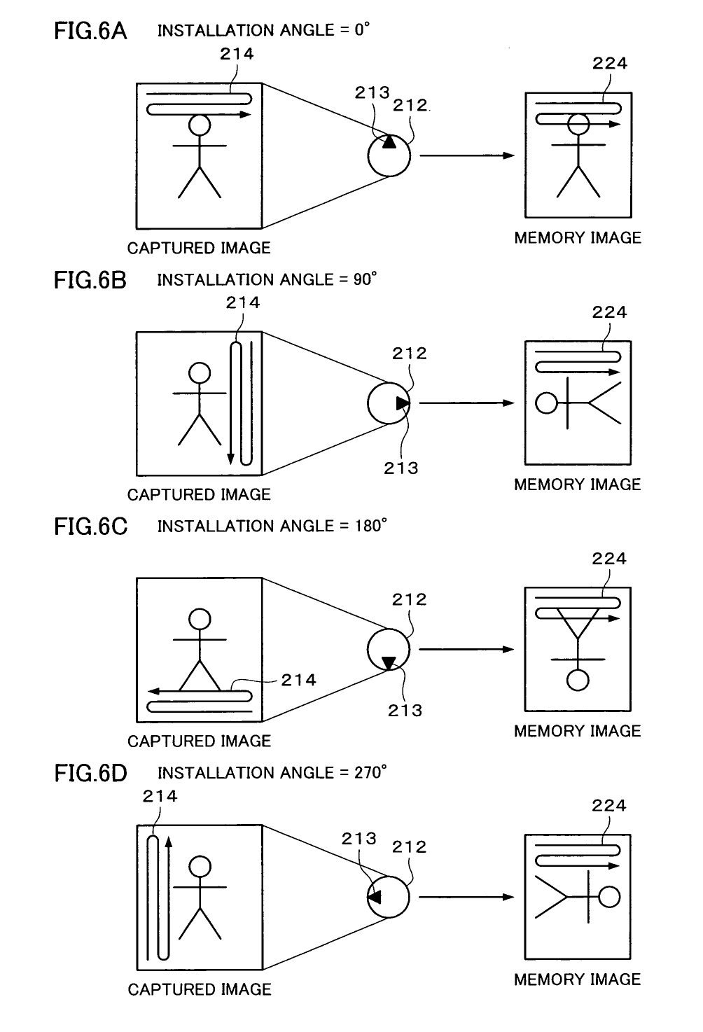

FIGS. 6A to 6D are illustrative of the installation angle of the camera module.

In FIGS. 6A to 6D, sections the same as the sections shown in FIGS. 3 and 4 are indicated by the same symbols. Description of these sections is appropriately omitted.

In one embodiment of the invention, the installation angle of the camera module is determined based on the reference direction in which the vertical direction of the image of the object captured by the CCD image sensor 212 (vertical direction of the captured image) coincides with the vertical direction of the object. The vertical direction of the captured image is determined when the mark 213 of the CCD image sensor 212 is positioned as shown in FIG. 6A.

The image data output according to the scan direction 214 of the CCD image sensor 212 is written into the image memory according to the write direction 224 of the image memory. In this case, the vertical direction of the memory image of the image memory coincides with the vertical direction of the captured image. In this case, the installation angle of the CCD image sensor module 210 including the CCD image sensor 212 as the camera module is defined as 0°.

When the mark 213 of the CCD image sensor 212 is positioned as shown in FIG. 6B, the vertical direction of the memory image rotates counterclockwise by 90° with respect to the vertical direction of the object when writing the image data into the image memory in the same manner as described above. In this case, the installation angle of the CCD image sensor module 210 is defined as 90° (=−270°).

When the mark 213 of the CCD image sensor 212 is positioned as shown in FIG. 6C, the vertical direction of the memory image rotates by 180° with respect to the vertical direction of the object when writing the image data into the image memory in the same manner as described above. In this case, the installation angle of the CCD image sensor module 210 is defined as 180° (=−180°).

When the mark 213 of the CCD image sensor 212 is positioned as shown in FIG. 6D, the vertical direction of the memory image rotates clockwise by 90° with respect to the vertical direction of the object when writing the image data into the image memory in the same manner as described above. In this case, the installation angle of the CCD image sensor module 210 is defined as 270° (=−90°).

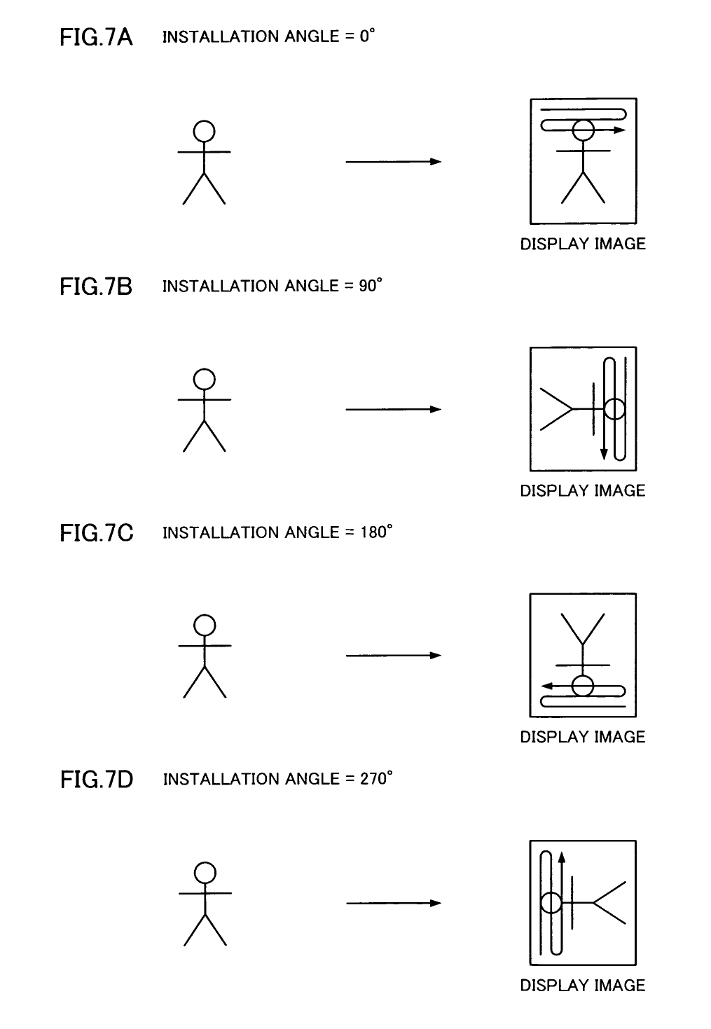

FIGS. 7A to 7D are illustrative of the installation angle of the display panel.

In FIGS. 7A to 7D, sections the same as the sections shown in FIGS. 3 and 4 are indicated by the same symbols. Description of these sections is appropriately omitted.

In one embodiment of the invention, the installation angle of the display panel is determined based on the vertical direction of a person who sees the image in the display panel. As shown in FIG. 7A, when the vertical direction of a person who sees the image in the display panel coincides with the vertical direction of the display image determined by the display scan direction of the display panel, the installation angle of the display panel is defined as 0°.

As shown in FIG. 7B, when the vertical direction of the display image rotates clockwise by 90° with respect to the vertical direction of a person who sees the image in the display panel, the installation angle of the display panel is defined as 90° (=−270°).

As shown in FIG. 7C, when the vertical direction of the display image rotates by 180° with respect to the vertical direction of a person who sees the image in the display panel, the installation angle of the display panel is defined as 180° (=−180°).

As shown in FIG. 7D, when the vertical direction of the display image rotates clockwise by 270′ with respect to the vertical direction of a person who sees the image in the display panel, the installation angle of the display panel is defined as 270° (=−90°).

As described with reference to FIGS. 6A to 6D and FIGS. 7A to 7D, since the installation angle of the camera module and the installation angle of the display panel are respectively defined based on the vertical direction of the object and the vertical direction of a person who sees the image in the display panel, the reference directions for the installation angle of the camera module and the installation angle of the display panel coincide with each other.

2.2 Comparison with Comparative Example

The effects of the display controller 10 shown in FIG. 2 are described below by comparing the display controller 10 with a comparative example of one embodiment of the invention.

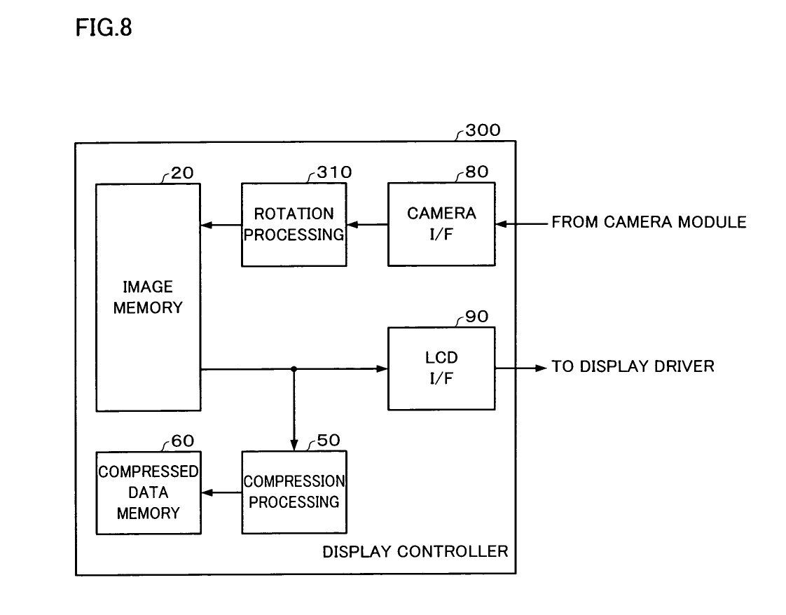

FIG. 8 is a block diagram of a configuration example of a display controller in a comparative example of one embodiment of the invention.

In FIG. 8, sections the same as the sections shown in FIG. 2 are indicated by the same symbols. Description of these sections is appropriately omitted.

A display controller 300 includes a rotation processing section 310 provided between the camera I/F circuit 80 and the image memory 20. The image data read from the image memory 20 is supplied to the compression processing section 50 and the LCD I/F circuit 90. The rotation processing section 310 performs processing of writing the image data after rotation processing into the image memory 20 in the same manner as the first rotation processing section 30 shown in FIG. 2. The rotation processing is processing of causing the vertical direction of the image of the image data to be supplied to the display driver (not shown) to rotate by a predetermined rotation angle. The function of the rotation processing section 310 may be realized by a circuit which generates the write address which specifies the write region of the image memory 20.

In the comparative example, the input rate of the image data from the camera module is lower than the output rate of the image data to the display driver in the same manner as in one embodiment of the invention. Therefore, the number of frames in which the processing of writing the image data for one frame into the image memory is performed within a unit time is smaller than the number of frames in which the processing of reading the image data for one frame from the image memory is performed within the unit time.

Therefore, the vertical direction of the image is rotated on the write side of the image memory 20 as in one embodiment of the invention and in the comparative example. When writing the image data after the rotation processing into the image memory 20, the write address of the image memory 20 becomes discontinuous due to the rotation angle. In this case, it is necessary to perform a random access operation for the image memory 20.

In one embodiment of the invention and the comparative example, the image data read from the image memory 20 is output to the display driver without rotating the vertical direction of the image expressed by the image data. This enables the read processing performed at 60 fps higher than that of the write processing (15 fps) to be realized by the sequential access operation for the image memory 20.

Specifically, the vertical direction of the image expressed by the image data stored in the image memory 20 can be caused to coincide with the vertical direction of the image expressed by the image data to be supplied to the display driver. This enables the read processing (60 fps) to be performed for the image memory 20 by the sequential access operation. This makes it unnecessary to additionally access the image memory 20, whereby power consumption accompanying the access operation for the image memory 20 can be significantly reduced.

On the other hand, in the comparative example shown in FIG. 8, the vertical direction of the image of the image data output to the display driver cannot be caused to differ from the vertical direction of the image of the image data subjected to the compression processing by the compression processing section 50. In this case, when the host reads the compressed data and attempts to perform additional processing or communication processing for the image data, it is necessary to perform processing of recovering the original vertical direction since the vertical direction of the image has been changed, whereby processing load imposed on the host is increased.

According to one embodiment of the invention, since the vertical direction of the image data can be changed on the read side for performing the compression processing, an increase in processing load imposed on the host can be prevented while reducing power consumption.

This advantage is described below.

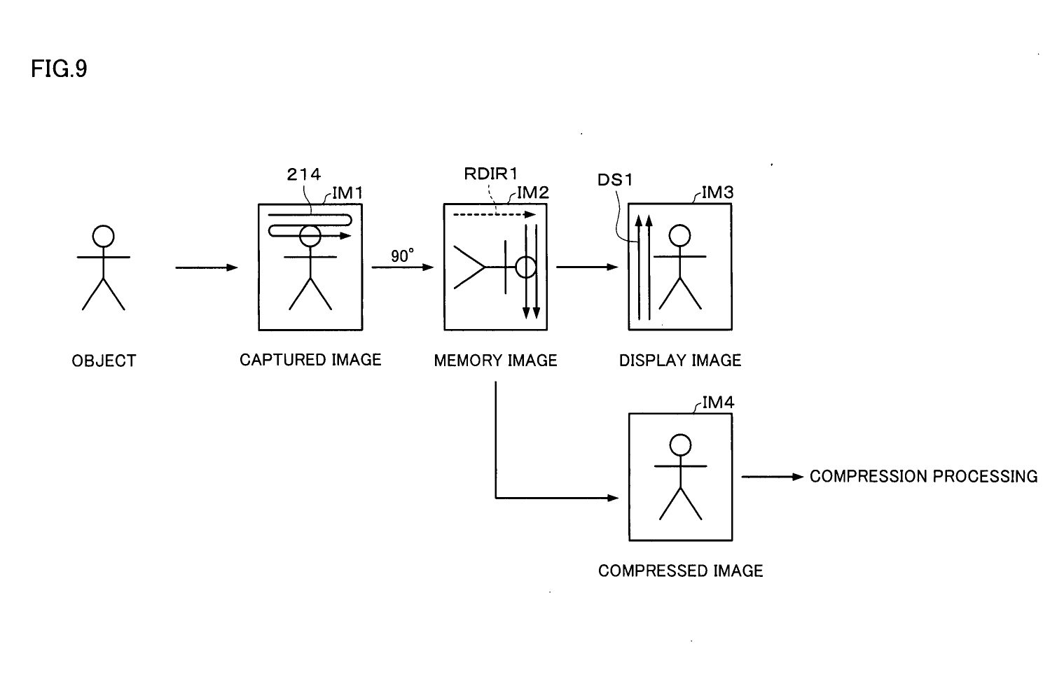

FIG. 9 is a diagram illustrative of the difference in sequence between one embodiment of the invention and the comparative example.

FIG. 9 shows the case where the installation angle of the CCD image sensor module 210 is 0° and the installation angle of the display panel is 270°. The difference between one embodiment of the invention and the comparative example is described below taking a sequence of generating a display image IM3 and a compression image IM4 as an example. The display image IM3 and the compression image IM4 have a vertical direction which coincides with the vertical direction of the object.

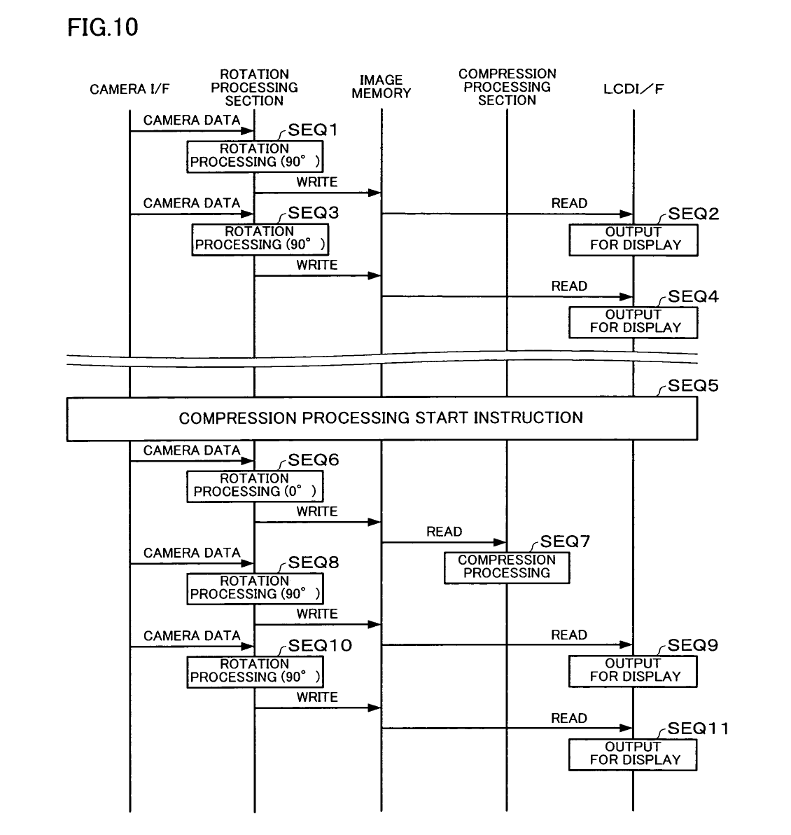

FIG. 10 shows an example of a sequence of the display controller in the comparative example when realizing the operation shown in FIG. 9.

Since the installation angle of the CCD image sensor module 210 is 0°, the vertical direction of a captured image IM1 of the object captured by the CCD image sensor 212 coincides with the vertical direction of the object, as shown in FIG. 6A. On the other hand, since the installation angle of the display panel is 270°, rotation processing SEQ1 which causes the vertical direction of the image to rotate clockwise by 90° is performed when writing the image data into the image memory, as shown in FIG. 7D. This processing is performed by the rotation processing section 310. As a result, a memory image IM2 expressed by the image data written into the image memory is obtained.

When outputting the image data to the display driver, the image data is sequentially read from the image memory in a read direction RDIR1, and output processing SEQ2 is then performed. In this case, since the read processing from the image memory is performed by the sequential access operation, the number of accesses can be reduced, and the image data can be read at high speed.

As a result, since the image data is displayed in the display panel in the order of a display scan direction DS1, the display image IM3 having a vertical direction which coincides with the vertical direction of the object is obtained.

In the subsequent processing, the image data of the image captured by the CCD image sensor 212 is input as camera data and output to the display driver in the same manner as described above (SEQ3 and SEQ4). This enables the image captured by the CCD image sensor 212 to be displayed in the display panel approximately in real time.

Suppose that the host issues a compression processing start instruction SEQ5. For example, the host which has detected that the shutter release button of the camera has been pressed stops writing the captured image into the image memory, and issues a compression processing start instruction in order to perform compression processing of the captured image.

In the display controller 300, the rotation angle of the rotation processing section 310 is set at 0° by the host. Therefore, when the image data of the image captured by the CCD image sensor 212 is input as camera data, the image data is directly written into the image memory without rotating the vertical direction of the image (0° rotation processing SEQ6). As a result, the memory image expressed by the image data written into the image memory differs from the memory image shown in FIG. 9.

Then, the image data is read from the image memory, and the compression processing section 50 performs compression processing SEQ7. In this case, the compression image IM4 is subjected to the compression processing.

In the display controller 300, the rotation angle of the rotation processing section 310 is again set at 90° by the host. Therefore, rotation processing SEQ8 which causes the vertical direction of the image to rotate clockwise by 90° is performed when writing the image data into the image memory. As a result, the memory image IM2 expressed by the image data written into the image memory is obtained. The image data is sequentially read from the image memory in the read direction RDIR1, and output processing SEQ9 is then performed.

In the subsequent processing, the image data of the image captured by the CCD image sensor 212 is input as camera data and output to the display driver in the same manner as described above (SEQ10 and SEQ11). This enables the image captured by the CCD image sensor 212 to be displayed in the display panel approximately in real time.

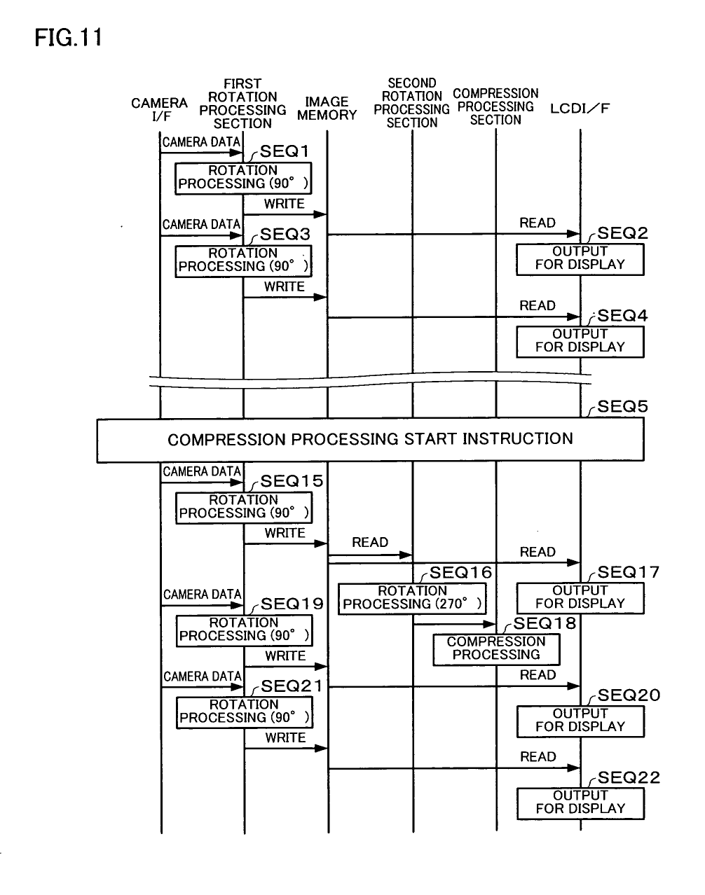

FIG. 11 shows an example of a sequence of the display controller according to one embodiment of the invention when realizing the operation shown in FIG. 9.

In FIG. 11, sections the same as the sections shown in FIG. 10 are indicated by the same symbols. Description of these sections is appropriately omitted.

The sequence until the compression processing start instruction is issued from the host (SEQ1 to SEQ5) is the same as the sequence shown in FIG. 10 except that the first rotation processing section 310 performs the 90° rotation processing performed by the rotation processing section 310.

When the compression processing start instruction SEQ5 has been issued from the host, the first rotation processing section 30 performs 90° rotation processing SEQ15, even though the installation angle of the CCD image sensor module 210 is 0°. Therefore, the memory image IM2 expressed by the image data written into the image memory is obtained.

After sequentially reading the image data in the read direction RDIR1, output processing SEQ17 is performed. As a result, since the image data is displayed in the display panel in the order of the display scan direction DS1, the display image IM3 having a vertical direction which coincides with the vertical direction of the object is obtained.

The second rotation processing section 40 reads the image data written by the rotation processing SEQ15 while performing rotation processing SEQ16 at a rotation angle of 270°. The vertical direction of the image can be caused to rotate by 270° by the rotation processing SEQ16 so that the compression image IM4 is obtained. The compression processing section 50 performs compression processing SEQ18 for the image data subjected to the rotation processing SEQ16.

In the subsequent processing, the image data of the image captured by the CCD image sensor 212 is input as the camera data and output to the display driver in the same manner as described above (SEQ19 to SEQ22). This enables the image captured by the CCD image sensor 212 to be displayed in the display panel approximately in real time.

As described above, in the comparative example, the rotation angle must be returned to the original rotation angle after changing the rotation angle for the compression processing. On the other hand, it is unnecessary to change the rotation angle according to one embodiment of the invention. Therefore, the sequence can be simplified (processing load imposed on the host can be reduced).

In the comparative example, the frame of the display image (display frame) differs from the frame of the image subjected to the compression processing (compression processing frame) for one frame, for example. According to one embodiment of the invention, since the compression processing can be performed for the display image, the display frame can be caused to coincide with the compression processing frame.

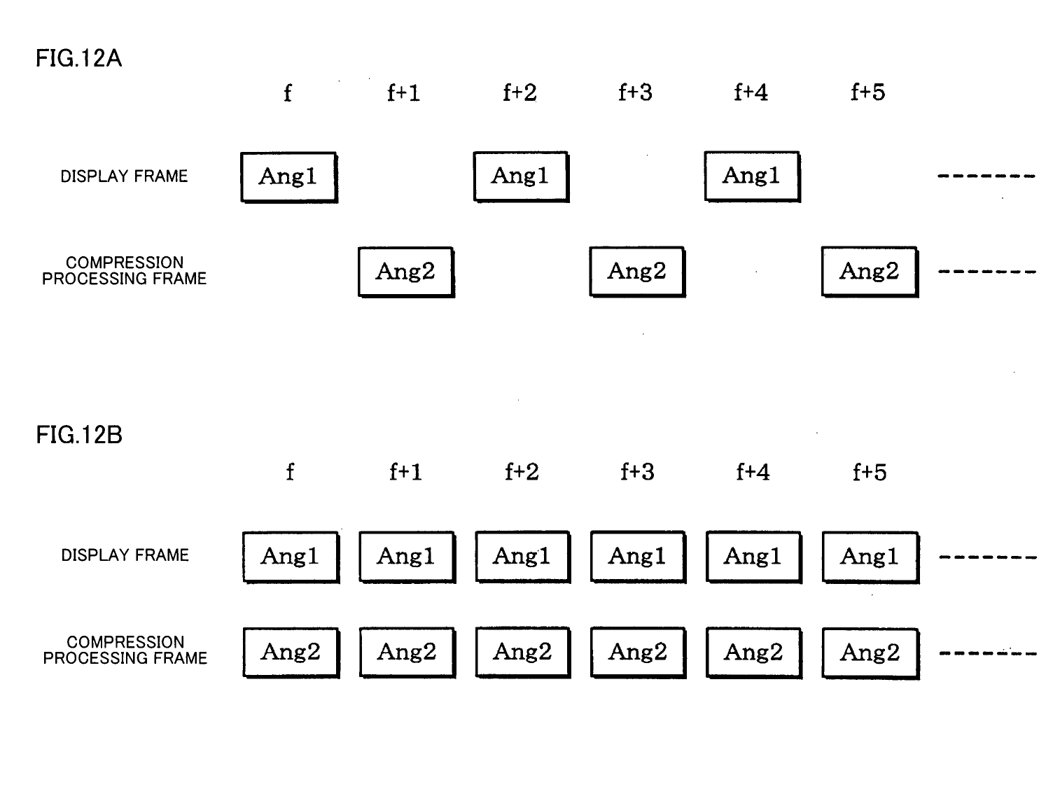

FIGS. 12A and 12B are schematic illustrative of the display frame and the compression processing frame in the comparative example and one embodiment of the invention.

FIG. 12A shows a processing example of the comparative example in consecutive frames f, f+1, f+2, . . . . FIG. 12B shows a processing example of one embodiment of the invention in consecutive frames f, f+1, f+2, . . . . In FIGS. 12A and 12B, display frame generation processing is indicated by Ang1, and compression processing frame generation processing is indicated by Ang2.

In the comparative example, since only the rotation processing using one rotation angle can be performed for the image data for one frame, if the display rotation processing is performed in the frame f (Ang1), the compression rotation processing cannot be performed using the image data in the frame f. Therefore, the rotation processing using the compression processing rotation angle is performed in the next frame f+1 (Ang2). Since the rotation processing using the compression processing rotation angle is performed in the frame f+1, the display rotation processing cannot be performed using the image data in the frame f+1.

According to one embodiment of the invention, the first and second rotation processing sections 30 and 40 independently perform the rotation processing using different rotation angles. Therefore, as shown in FIG. 12B, the image data can be generated by performing the rotation processing for the image data in the consecutive frames (Ang1 and Ang2). This allows the frame of the image displayed in the display panel to be the same as the frame of the image subjected to the compression processing and stored, whereby occurrence of a situation in which the image displayed in the display panel differs from the image continuously captured by the camera module or the image stored as a video image can be prevented.

2.3 Example of Rotation Processing According to Embodiment

A detailed processing example of the first and second rotation processing sections 30 and 40 of the display controller according to one embodiment of the invention is described below.

The first rotation processing section 30 changes the vertical direction of the image expressed by the image data retained in the image memory 20 by changing the write address of the image memory 20 corresponding to the first rotation angle. The second rotation processing section 40 changes the vertical direction of the image expressed by the image data read from the image memory 20 by changing the read address of the image memory 20 corresponding to the second rotation angle. Since the write address generation processing of the first rotation processing section 30 is the same as the read address generation processing of the second rotation processing section 40, the following description focuses on the processing of the first rotation processing section 30.

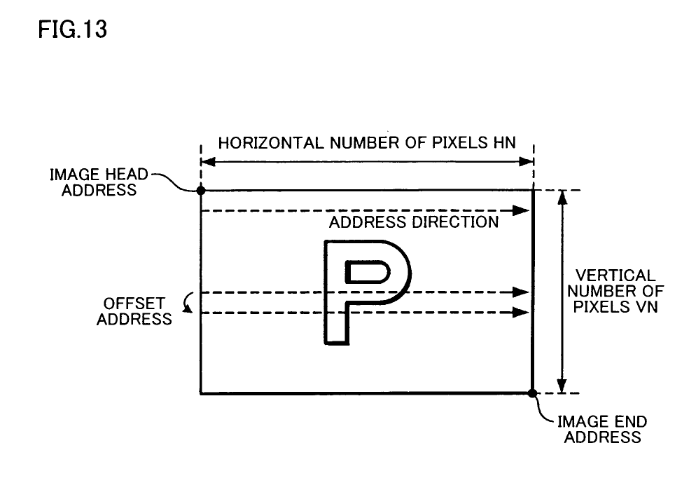

FIG. 13 is illustrative of control information used for the write address generation processing of the first rotation processing section 30.

In the image memory 20, image data for each pixel of a quadrilateral image, of which the number of pixels in the horizontal direction is a horizontal number of pixels HN and the number of pixels in the vertical direction is a vertical number of pixels VN, is stored in the storage region from an image head address to an image end address. The image data for each pixel in the horizontal direction is stored in the storage region of the image memory 20 designated by the write address which is updated based on the head address of each line in the horizontal direction.

The end address of one line in the horizontal direction need not be continuous with the head address of the next line. The address interval between the head address of one line and the head address of the next line is defined as an offset address. When the end address of one line is continuous with the head address of the next line, the offset address is zero.

For example, the host must designate the start address and the offset address corresponding to the first rotation angle when indicating the first rotation angle to the display controller.

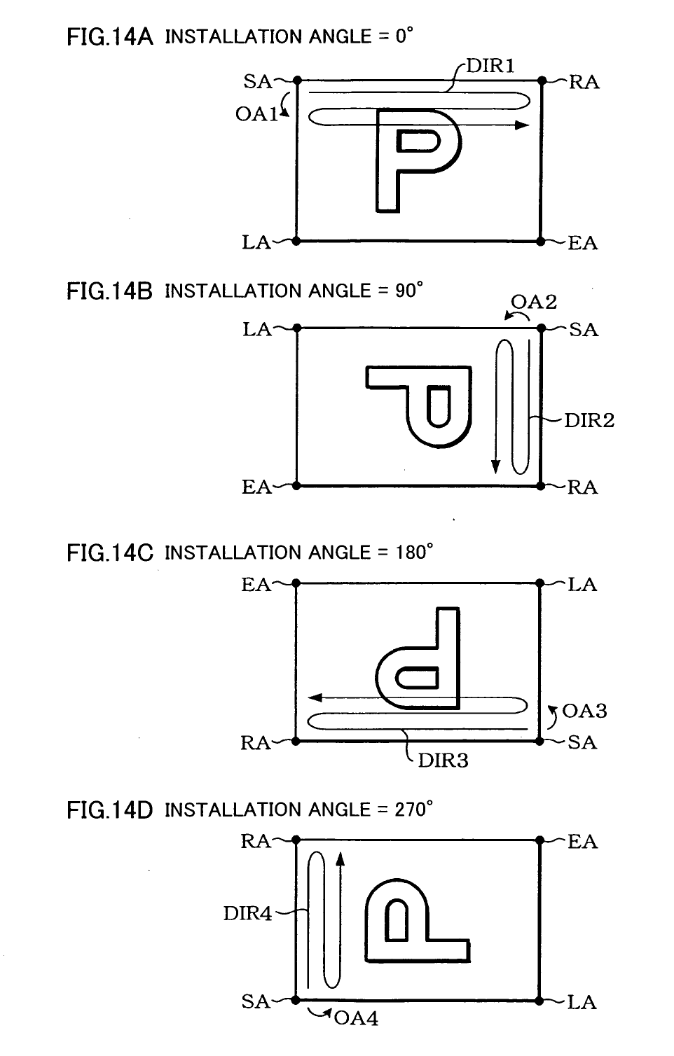

FIGS. 14A to 14D are illustrative of a setting example of the write start address and the offset address corresponding to the first rotation angle. FIGS. 14A to 14D schematically show the captured image in association with the write address of the image memory.

FIG. 14A schematically shows the write start address, the write address update direction, and the offset address when the first rotation angle is set at 0°. In this case, since the vertical direction of the image after the first rotation processing is the same as the vertical direction of the image before the rotation processing, the address at the upper left is set as a write start address SA and the write address is updated in an update direction DIR1. The update direction DIR1 corresponds to the order in which the image data of each pixel is supplied from the CCD image sensor 212.

When the write address of a given line has reached the end address in the update direction, the head address of the next line is calculated by using an offset address OA1. The pixels for one line thus written are the pixels of the memory image for one line in the horizontal direction.

FIG. 14B schematically shows the write start address, the write address update direction, and the offset address when the first rotation angle is set at 90′. In this case, the address at the upper right is set as the write start address SA, and the write address is updated in an update direction DIR2. The update direction DIR2 corresponds to the order in which the image data of each pixel is supplied from the CCD image sensor 212.

When the write address of a given line has reached the end address in the update direction, the head address of the next line is calculated by using an offset address OA2. The pixels for one line thus written are the pixels of the memory image for one line in the horizontal direction.

FIG. 14C schematically shows the write start address, the write address update direction, and the offset address when the first rotation angle is set at 180°. In this case, the address at the lower right is set as the write start address SA, and the write address is updated in an update direction DIR3. The update direction DIR3 corresponds to the order in which the image data of each pixel is supplied from the CCD image sensor 212.

When the write address of a given line has reached the end address in the update direction, the head address of the next line is calculated by using an offset address OA3. The pixels for one line thus written are the pixels of the memory image for one line in the horizontal direction.

FIG. 14D schematically shows the write start address, the write address update direction, and the offset address when the first rotation angle is set at 270°. In this case, the address at the lower left is set as the write start address SA, and the write address is updated in an update direction DIR4. The update direction DIR4 corresponds to the order in which the image data of each pixel is supplied from the CCD image sensor 212.

When the write address of a given line has reached the end address in the update direction, the head address of the next line is calculated by using an offset address OA4. The pixels for one line thus written are the pixels of the memory image for one line in the horizontal direction.

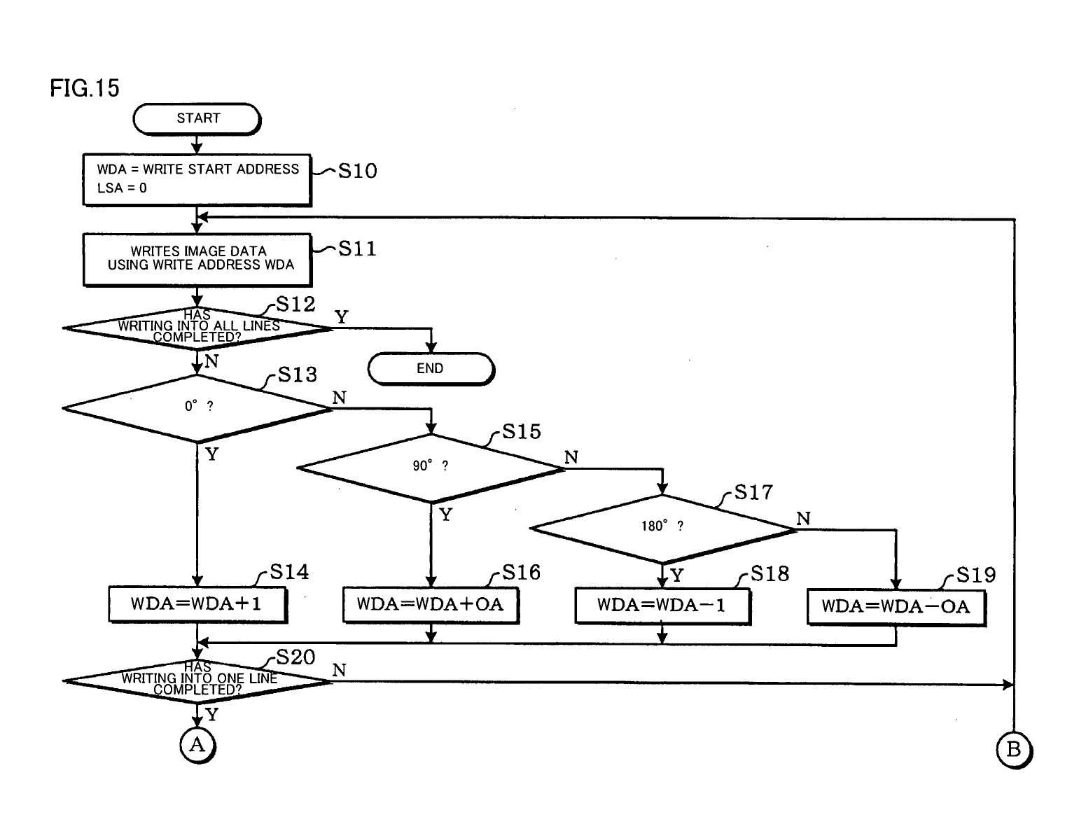

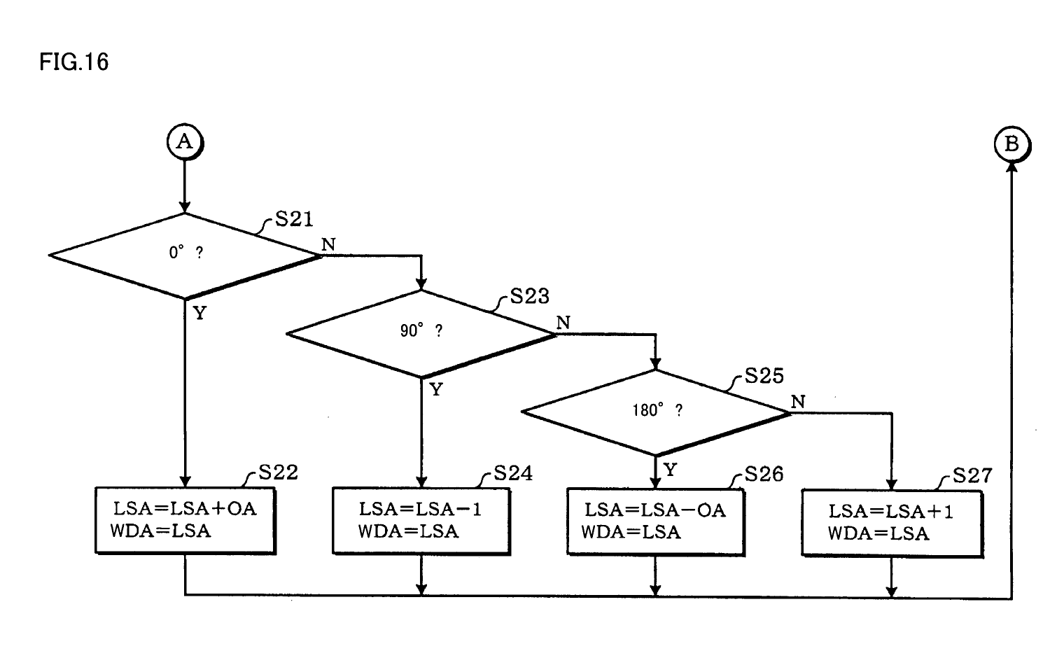

FIGS. 15 and 16 show an operation flow of the first rotation processing section 30. In FIGS. 15 and 16, the image data for one pixel is stored in the storage region designated by one address for convenience of description.

As shown in FIGS. 14A to 14D, the write start address corresponding to the first rotation angle is set as a write address WDA, and a variable LSA is initialized to zero (step S10).

Then, the image data is written into the image memory 20 by using the write address WDA (step S11).

When the image data has been written into all the lines (step S12: Y), the processing is finished (END).

When the image data has not been written into all the lines in the step S12 (step S12: N), whether or not the first rotation angle has been set at 0° by the host is determined (step S13).

When it is determined that the first rotation angle has been set at 0° in the step S13 (step S13: Y), “1” is added to the write address WDA to update the write address WDA (step S14).

When it is determined that the first rotation angle has not been set at 0° in the step S13 (step S13: N), whether or not the first rotation angle has been set at 90° is determined (step S15).

When it is determined that the first rotation angle has been set at 90° in the step S15 (step S15: Y), the offset address OA is added to the write address WDA to update the write address WDA (step S16). The offset address OA is set by the host corresponding to the first rotation angle, as shown in FIGS. 14A to 14D.

When it is determined that the first rotation angle has not been set at 90′ in the step S15 (step S15: N), whether or not the first rotation angle has been set at 180° is determined (step S17).

When it is determined that the first rotation angle has been set at 180° in the step S17 (step S17: Y), “1” is subtracted from the write address WDA to update the write address WDA (step S18).

When it is determined that the first rotation angle has not been set at 180° in the step S17 (step S17: N), it is determined that the first rotation angle has been set at 270°. Then, the offset address OA is subtracted from the write address WDA to update the write address WDA (step S19).

After the step S14, the step S16, the step S18, and the step S19, whether or not writing of the image data for one line has been completed is determined (step S20). When it is determined that writing of the image data for one line has not been completed (step S20: N), the image data is written in the step S11.

When it is determined that writing of the image data for one line has been completed in the step S20 (step S20: Y), whether or not the first rotation angle has been set at 0° is determined (step S21).

When it is determined that the first rotation angle has been set at 0° in the step S21 (step S21: Y), the offset address OA is added to the variable LSA to update the variable LSA, and the variable LSA is set as the write address WDA (step S22). Then, the processing in the step S11 is performed again.

When it is determined that the first rotation angle has not been set at 0° in the step S21 (step S21: N), whether or not the first rotation angle has been set at 90° is determined (step S23).

When it is determined that the first rotation angle has been set at 90° in the step S23 (step S23: Y), “1” is subtracted from the variable LSA to update the variable LSA, and the variable LSA is set as the write address WDA (step S24). Then, the processing in the step S11 is performed again.

When it is determined that the first rotation angle has not been set at 90° in the step S23 (step S23: N), whether or not the first rotation angle has been set at 180° is determined (step S25).

When it is determined that the first rotation angle has been set at 180° in the step S25 (step S25: Y), the offset address OA is subtracted from the variable LSA to update the variable LSA, and the variable LSA is set as the write address WDA (step S26). Then, the processing in the step S11 is performed again.

When it is determined that the first rotation angle has not been set at 180° in the step S25 (step S25: N), it is determined that the first rotation angle has been set at 270°. Then, “1” is added to the variable LSA to update the variable LSA, and the variable LSA is set as the write address WDA (step S27). Then, the processing in the step S11 is performed again.

The image data is written into the image memory 20 by the random access operation or the sequential access operation by using the write address WDA updated in this manner. The second rotation processing section 40 similarly generates the read address, and reads the image data from the image memory 20 by the random access operation or the sequential access operation.

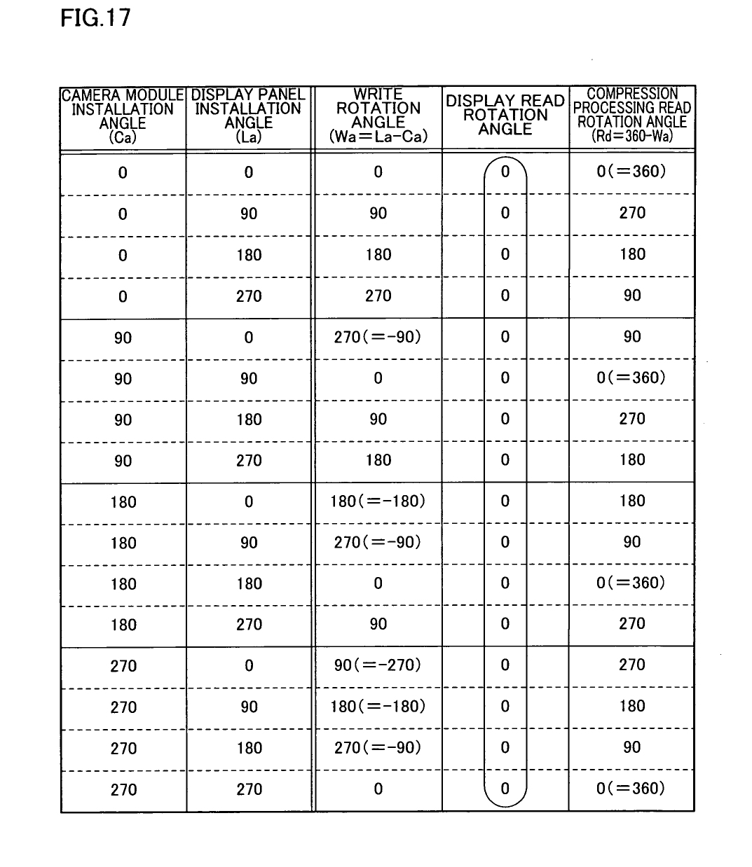

FIG. 17 shows the relationship among the installation angle of the camera module, the installation angle of the display panel, the first rotation angle, and the second rotation angle according to one embodiment of the invention.

In FIG. 17, the first rotation angle corresponds to the write rotation angle. The second rotation angle corresponds to the compression processing read rotation angle.

As shown in FIG. 17, the write rotation angle (first rotation angle) is calculated based on the installation angle of the camera module (imaging section) which captures the image data before the first rotation processing and the installation angle of the display panel. In more detail, when causing the vertical direction of the image of the image data before the first rotation processing to rotate by a rotation angle Ca with respect to a predetermined orientation in a predetermined rotation direction and causing the vertical direction of the image of the image data supplied to the display driver to rotate by a rotation angle La with respect to the predetermined orientation in the predetermined rotation direction, the first rotation angle is (La−Ca)°. Specifically, when the installation angle of the camera module is Ca and the installation angle of the display panel is La, the write rotation angle Wa (first rotation angle) is calculated by (La−Ca). For example, since clockwise 270° and counterclockwise 90° are considered to be equivalent rotation angles, the write rotation angle Wa can be expressed by the above expression.

As shown in FIG. 17, the vertical direction of the image of the image data supplied to the display driver is 0°. This is because the read processing at a high rate is performed by the sequential access operation by setting the write rotation angle.

The compression processing read rotation angle (second rotation angle) is also calculated based on the installation angle of the camera module (imaging section) which captures the image data before the first rotation processing and the installation angle of the display panel. In more detail, when the first rotation angle is Wa° (0≦Wa<360), the second rotation angle is (360−Wa)°. This is because the rotation angle 0° and the rotation angle 360° can be considered to be equivalent rotation angles, for example.

As described above, when the installation angle Ca of the camera module and the installation angle La of the display panel have been determined, the host 4 connected with the display controller 10 according to one embodiment of the invention may set the first and second rotation angles according to the relationship shown in FIG. 17.

2.4 Detailed Configuration Example

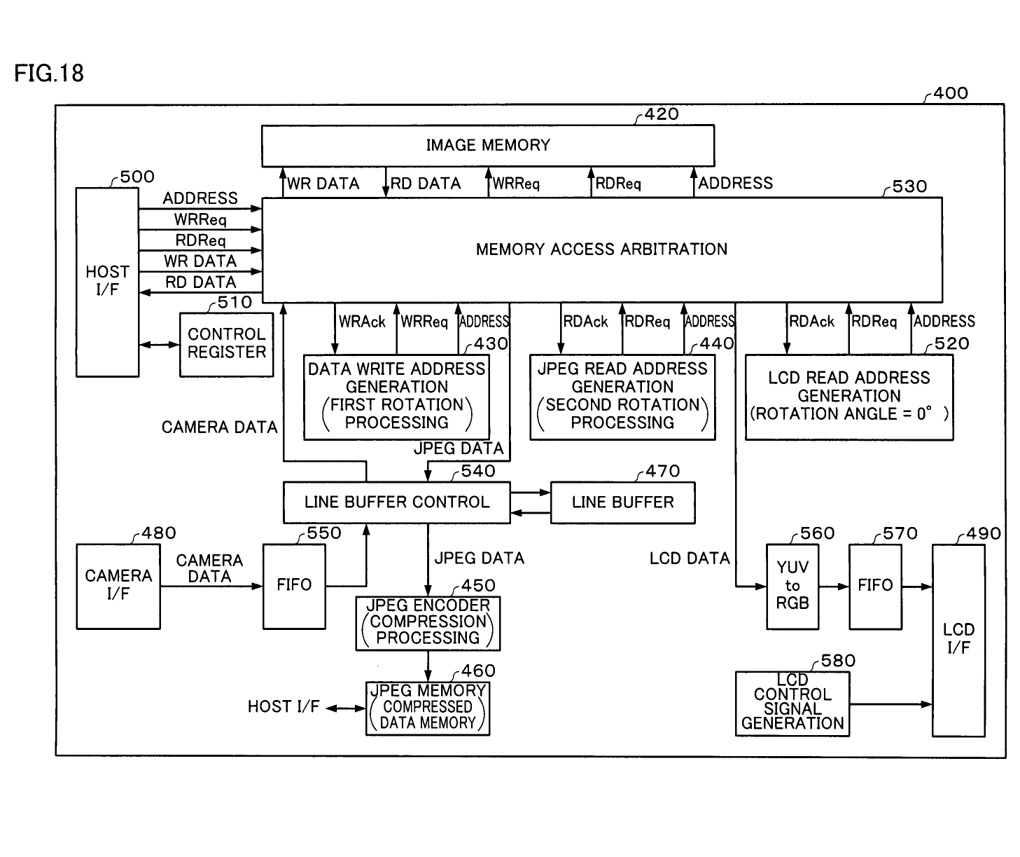

FIG. 18 shows a block diagram of a detailed hardware configuration example of the display controller according to one embodiment of the invention.

In a display controller 400 shown in FIG. 18, the function of the image memory 20 shown in FIG. 2 is realized by an image memory 420. The function of the first rotation processing section 30 shown in FIG. 2 is realized by a data write address generation circuit 430 (or data write address generation circuit 430 and line buffer control circuit 540). The function of the second rotation processing section 40 shown in FIG. 2 is realized by a JPEG read address generation circuit 440 (or JPEG read address generation circuit 440 and line buffer control circuit 540). The function of the compression processing section 50 shown in FIG. 2 is realized by a JPEG encoder 450. The function of the compressed data memory 60 shown in FIG. 2 is realized by a JPEG memory 460. The function of the line buffer 70 shown in FIG. 2 is realized by a line buffer 470. The function of the camera I/F circuit 80 shown in FIG. 2 is realized by a camera I/F circuit 480. The function of the LCD I/F circuit 90 shown in FIG. 2 is realized by an LCD I/F circuit 490.

The display controller 400 further includes a host I/F circuit 500, a control register 510, an LCD read address generation circuit 520, a memory access arbitration section 530, a line buffer control circuit 540, a first-in first-out (FIFO) 550, a YUV-RGB conversion circuit 560, a FIFO 570, and an LCD control signal generation circuit 580.

Image data and setting data for the control register 510 are input to the host I/F circuit 500 from the host. The host I/F circuit 500 performs interface processing (processing of receiving data from the host or signal buffering). The host I/F circuit 500 supplies the image data after the interface processing to the memory access arbitration section 530 and supplies the setting data after the interface processing to the control register 510. The setting data read from the control register 510 is input to the host I/F circuit 500. The host I/F circuit 500 performs interface processing (processing of transmitting data to the host or signal buffering), and supplies the setting data after the interface processing to the host.

The setting data for controlling each section of the display controller 400 is set in the control register 510. A control signal is generated based on the setting data so that each section of the display controller 400 is controlled.

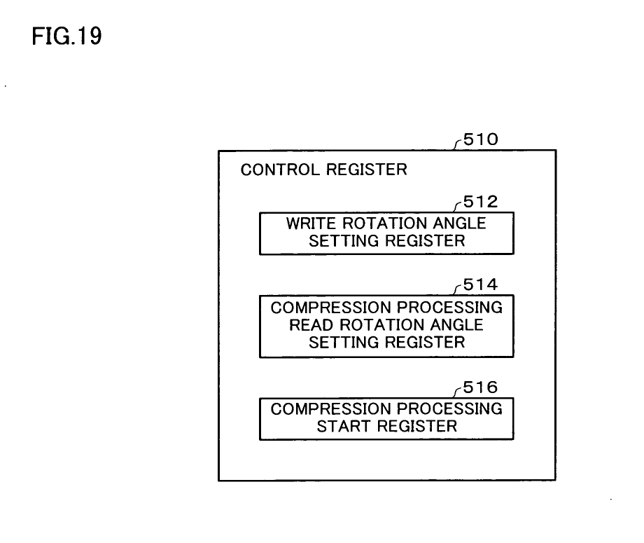

FIG. 19 is a block diagram of a configuration example of the control register 510 shown in FIG. 18.

The control register 510 includes a write rotation angle setting register (first rotation angle setting register) 512, a compression processing read rotation angle setting register (second rotation angle setting register) 514, and a compression processing start register 516.

The write rotation angle of the data write address generation circuit 430 which functions as the first rotation processing section is set in the write rotation angle setting register 512 through the host I/F circuit 500. The write rotation angle corresponds to the first rotation angle shown in FIG. 2.

The compression processing read rotation angle of the JPEG read address generation circuit 440 which functions as the second rotation processing section is set in the compression processing read rotation angle setting register 514 through the host I/F circuit 500. The compression processing read rotation angle corresponds to the second rotation angle shown in FIG. 2.

In the display controller 400, the compression processing starts when the host accesses the compression processing start register 516 through the host I/F circuit 500. After the compression processing has started, writing of image data for at least one frame into the image memory 420 is stopped.

The control register 510 includes registers (not shown) for setting the image head address, the image end address, the offset address, the horizontal number of pixels, and the vertical number of pixels shown in FIG. 13. The write address and the read address of the image memory 420 are generated by using the data set in these registers according to the flow described with reference to FIGS. 15 and 16.

Now, refer to FIG. 18 again. The LCD read address generation circuit 520 generates the read address for reading image data output to the display driver through the LCD I/F circuit 490. The LCD read address generation circuit 520 generates the read address in the same manner as the JPEG read address generation circuit 440 when the compression processing read rotation angle is set at 0°.

The memory access arbitration section 530 arbitrates among access requests for the image memory 420 from the host I/F circuit 500, the data write address generation circuit 430, the JPEG read address generation circuit 440, and the LCD read address generation circuit 520. The memory access arbitration section 530 arbitrates among write request signals WRReq and read request signals RDReq from these circuits, and notifies the circuit which is permitted to access the image memory 420 as a result of arbitration of permission of access and end of access by using acknowledge signals WRAck and RDAck corresponding to the request signals.

The line buffer control circuit 540 controls access to the line buffer 470. The line buffer control circuit 540 controls buffering of camera data temporarily retained in the FIFO 550 or JPEG data read from the image memory 420.

When writing the image data from the FIFO 550 into the image memory 420, the image data buffered in the line buffer 470 by the line buffer control circuit 540 is written into the write region specified by the write address generated by the data write address generation circuit 430. When reading the image data from the image memory 420, the image data read from the read region specified by the read address generated by the JPEG read address generation circuit 440 is buffered in the line buffer 470 by the line buffer control circuit 540. The JPEG encoder 450 performs compression processing of the image data buffered in the line buffer 470.

The FIFO 550 functions as a first-in first-out storage circuit. Image data from the camera module is sequentially stored in the FIFO 550 by the camera I/F circuit 480, and the image data is output to the image memory 420 as camera data.

The YUV-RGB conversion circuit 560 converts the expression of the image data (LCD data) read from the read region of the image memory 420 specified by the read address generated by the LCD read address generation circuit 520. The image data in the YUV format is retained in the image memory 420, and the YUV-RGB conversion circuit 560 converts the image data in the YUV format into the image data in the RGB format.

The LCD data converted by the YUV-RGB conversion circuit 560 is sequentially stored in the FIFO 570. The FIFO 570 functions as a first-in first-out storage circuit. The FIFO 570 outputs the LCD data to the LCD I/F circuit 490.

The LCD control signal generation circuit 580 generates an LCD control signal which is a display synchronization signal such as a vertical synchronization signal, a horizontal synchronization signal, and a dot clock signal supplied to the display driver together with the LCD data (image data) output from the FIFO 570.

The JPEG encoder 450 performs compression processing specified by the JPEG standard for the image data from the image memory 420, and writes the image data into the JPEG memory 460 as compressed data. The compressed data written into the JPEG memory 460 is read by the host through the host I/F circuit 500, for example.

In FIG. 18, the JPEG read address generation circuit 440 and the LCD read address generation circuit 520 may be realized by one circuit. However, JPEG data and LCD data can be read at the same time by separately providing the JPEG read address generation circuit 440 and the LCD read address generation circuit 520 as shown in FIG. 18, so that JPEG encoding and LCD display can be processed at the same time, for example.

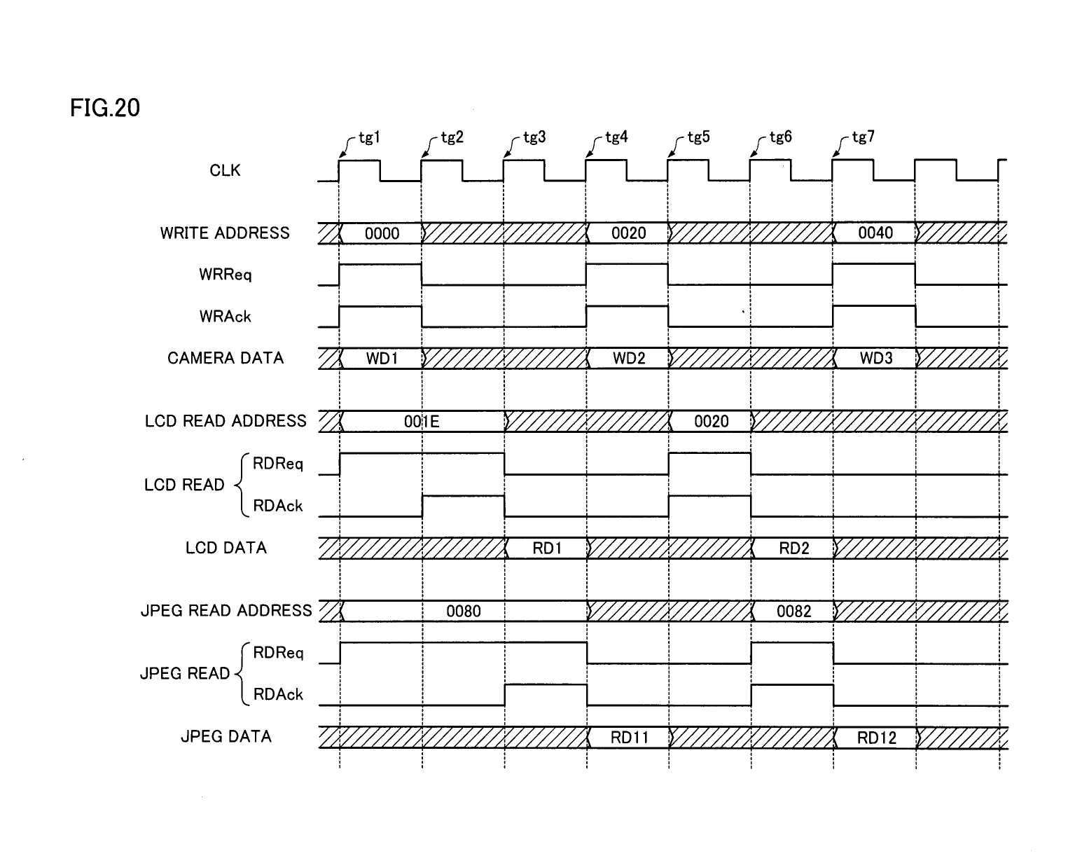

FIG. 20 is a timing diagram of an operation example of the display controller 400 shown in FIG. 18.

FIG. 20 shows an operation example when the camera data write request, the LCD data read request, and the JPEG data read request are issued to the memory access arbitration section 530 at the same time. In the memory access arbitration section 530, the priority is given to the camera data write request, the LCD data read request, and the JPEG data read request in that order. Specifically, the camera data write request is given the highest priority. In more detail, the processing of writing the image data into the image memory 420 is given priority over the processing of reading the image data from the image memory 420. This aims at preventing the camera data from being lost due to delay of writing of the image data into the image memory 420.

At a timing tg1 in FIG. 20, the data write address generation circuit 430 outputs a write address “0000” and write data WD1 as camera data from the FIFO 550, and sets the write request signal WRReq to active. At the timing tg1, the LCD read address generation circuit 520 outputs an LCD read address “001E” and sets the read request signal RDReq to active. At the timing tg1, the JPEG read address generation circuit 440 outputs a JPEG read address “0080” and sets the read request signal RDReq to active.

In this case, the memory access arbitration section 530 selects the write request signal WRReq from the data write address generation circuit 430 which is given the highest priority, and sets the acknowledge signal WRAck for the data write address generation circuit 430 to active. As a result, the write data WD1 is written into the write region of the image memory 420 specified by the write address “0000”. When the write processing has been completed, the memory access arbitration section 530 sets the acknowledge signal WRAck to inactive (timing tg2).

Then, the memory access arbitration section 530 selects the read request signal RDReq from the LCD read address generation circuit 520 which is given the second priority, and sets the acknowledge signal RDAck for the LCD read address generation circuit 520 to active (timing tg2). As a result, LCD data RD1 is read from the read region of the image memory 420 specified by the LCD read address “001E”. When the read processing has been completed, the memory access arbitration section 530 sets the acknowledge signal RDAck to inactive (timing tg3).

Then, the memory access arbitration section 530 selects the write request signal RDReq from the JPEG read address generation circuit 440, and sets the acknowledge signal RDAck for the JPEG read address generation circuit 440 to active (timing tg3). As a result, JPEG data RD11 is read from the read region of the image memory 420 specified by the JPEG read address “0080”. When the read processing has been completed, the memory access arbitration section 530 sets the acknowledge signal RDAck to inactive (timing tg4).

At the timing tg4, the data write address generation circuit 430 outputs a write address “0020” and write data WD2 as camera data from the FIFO 550, and sets the write request signal WRReq to active. The memory access arbitration section 530 immediately sets the acknowledge signal WRAck for the data write address generation circuit 430 to active. As a result, the write data WD2 is written into the write region of the image memory 420 specified by the write address “0020”. When the write processing has been completed, the memory access arbitration section 530 sets the acknowledge signal WRAck to inactive (timing tg5).

At the timing tg5, the LCD read address generation circuit 520 outputs a read address “0020” and sets the read request signal RDReq to active. The memory access arbitration section 530 sets the acknowledge signal RDAck for the LCD read address generation circuit 520 to active. As a result, LCD data RD2 is read from the read region of the image memory 420 specified by the LCD read address “0020”. When the read processing has been completed, the memory access arbitration section 530 sets the acknowledge signal RDAck to inactive (timing tg6).

At the timing tg6, the JPEG read address generation circuit 440 outputs a read address “0082” and sets the read request signal RDReq to active. The memory access arbitration section 530 sets the acknowledge signal RDAck for the JPEG read address generation circuit 440 to active. As a result, JPEG data RD12 is read from the read region of the image memory 420 specified by the JPEG read address “0082”. When the read processing has been completed, the memory access arbitration section 530 sets the acknowledge signal RDAck to inactive (timing tg7).

3. Electronic Instrument

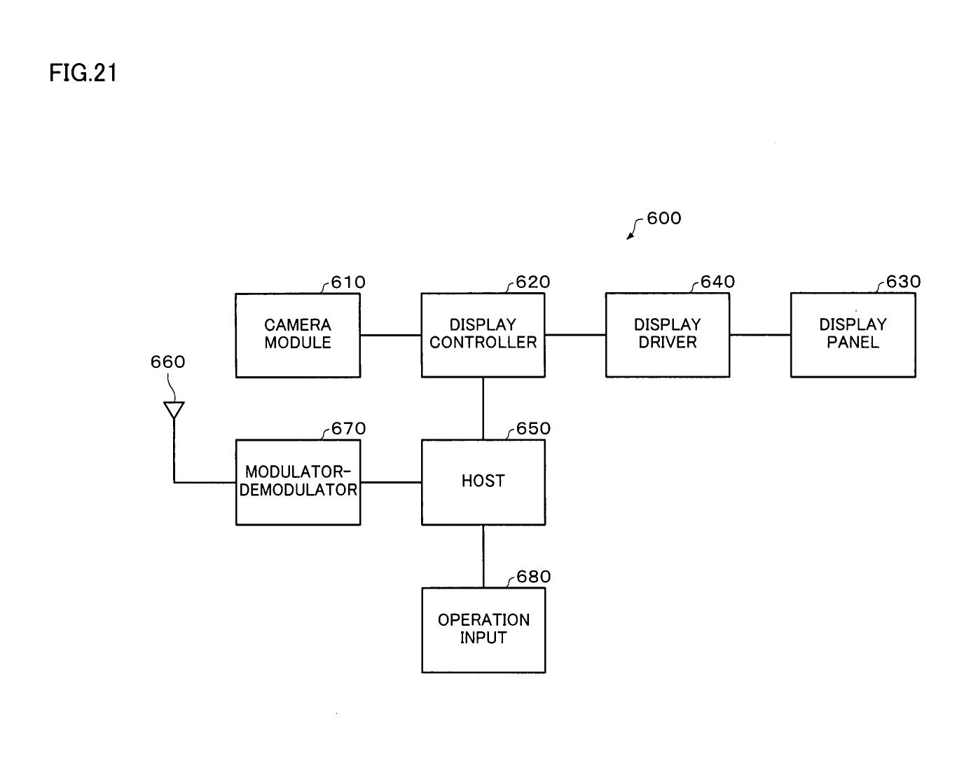

FIG. 21 is a block diagram of a configuration example of an electronic instrument to which the display controller according to one embodiment of the invention is applied. FIG. 21 is a block diagram of a configuration example of a portable telephone as an example of the electronic instrument.

A portable telephone 600 includes a camera module 610. The camera module 610 corresponds to the CCD image sensor module 210 shown in FIGS. 3 and 4, and may include a CCD image sensor. The camera module 610 supplies data of an image captured by the CCD image sensor to a display controller 620.

The portable telephone 600 includes a display panel 630. An LCD panel may be used as the display panel 630. In this case, the display panel 630 is driven by a display driver 640. The display panel 630 includes a plurality of scan lines, a plurality of data lines, and a plurality of pixels. The display driver 640 has a function of a scan driver which selects the scan lines in units of one or more scan lines, and has a function of a data driver which supplies voltage corresponding to the image data to the data lines.

The display controller 620 is connected with the display driver 640, and supplies image data to the display driver 640. The display controller 10 shown in FIG. 2 or the display controller 400 shown in FIG. 18 may be used as the display controller 620.

A host 650 is connected with the display controller 620. The host 650 corresponds to the host 4 shown in FIG. 2, and controls the display controller 620. The host 650 demodulates image data received through an antenna 660 (or compressed data obtained by compressing the image data) by using a modulator-demodulator section 670, and supplies the demodulated image data to the display controller 620. The display controller 620 causes the display driver 640 to display an image in the display panel 630 based on the image data (or image data obtained by decompressing compressed data).

The host 650 modulates the image data generated by the camera module 610 or compressed data obtained by compressing the image data by using the modulator-demodulator section 670, and directs transmission of the modulated data to another communication device through the antenna 660.

The host 650 performs image data transmission-reception processing, rotation processing, mirror image reversal processing, imaging using the camera module 610, compression processing of captured image data, and display processing of the display panel based on operation information from an operation input section 680.

Therefore, the portable telephone 600 (electronic instrument in a broad sense) shown in FIG. 21 may include the display panel 630, the display controller 620 according to one embodiment of the invention, and the display driver 640 which drives the display panel 630 based on image data supplied by the display controller 620. The portable telephone 600 may include the host 650 to which image data is input from the display controller 620 or from which image data is output to the display controller 620.

In the portable telephone 600, the vertical direction of the image of the image data captured by the camera module 610 is fixed. However, the vertical direction of the image displayed in the display panel 630 can be caused to coincide with the vertical direction of the image subjected to the compression processing. Therefore, the vertical direction of the image displayed in the display panel 630 can be caused to coincide with the vertical direction of the image of the image data included in the data transmitted through the antenna 660.

FIG. 21 illustrates the LCD panel as an example of the display panel 630. However, the invention is not limited thereto. The display panel 630 may be an electroluminescence display device or a plasma display device. The invention may be applied to a display controller which supplies image data to a display driver which drives such a display panel.

The invention is not limited to the above-described embodiments. Various modifications and variations may be made within the spirit and scope of the invention. In FIGS. 1, 2, 18, 19, and 21, all the circuit blocks need not be provided, and some of the circuit blocks may be omitted.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. A display controller which supplies image data to a display driver which drives a display panel, the display controller comprising:
an image memory for storing image data;
a first rotation processing section which performs processing of writing the image data after first rotation processing into the image memory, the first rotation processing causing a vertical direction of an image of the image data to be supplied to the display driver to rotate by a first rotation angle;
a second rotation processing section which performs processing of reading the image data after second rotation processing from the image memory, the second rotation processing causing a vertical direction of an image of the image data stored in the image memory to rotate by a second rotation angle; and
a compression processing section which performs compression processing of the image data stored in the image memory,
wherein the image data read from the image memory by a sequential access operation is supplied to the display driver without performing the second rotation processing for the image data stored in the image memory, and the image data read from the image memory by the second rotation processing section is supplied to the compression processing section.

2. The display controller as defined in claim 1, further comprising:
a line buffer which retains at least part of the image data,
wherein the image data is retained in the line buffer and the first rotation processing is performed by using the retained image data when performing the processing of writing the image data into the image memory; and
wherein the image data read from the image memory by the sequential access operation is retained in the line buffer and the second rotation processing is performed by using the retained image data when performing the processing of reading the image data from the image memory.

3. The display controller as defined in claim 1,
wherein the number of frames in which the processing of writing the image data for one frame into the image memory is performed within a unit time is smaller than the number of frames in which the processing of reading the image data for one frame from the image memory is performed within the unit time.

4. The display controller as defined in claim 1,
wherein the processing of writing the image data into the image memory is given priority over the processing of reading the image data from the image memory.

5. The display controller as defined in claim 1, further comprising:
an input image interface for inputting the image data before the first rotation processing; and
a display driver interface for outputting the image data read from the image memory to the display driver.

6. The display controller as defined in claim 1,
wherein the first rotation angle is set based on an installation angle of an imaging section which captures the image data before the first rotation processing, and an installation angle of the display panel.

7. The display controller as defined in claim 1,
wherein, when causing the vertical direction of an image of the image data before the first rotation processing to rotate by a rotation angle Ca with respect to a predetermined orientation in a predetermined rotation direction and causing the vertical direction of an image of the image data supplied to the display driver to rotate by a rotation angle La with respect to a predetermined orientation in a predetermined rotation direction, the first rotation angle is (La−Ca)°.

8. The display controller as defined in claim 1,
wherein, when the first rotation angle is Wa° (0≦Wa<360), the second rotation angle is (360−Wa)°.

9. An electronic instrument, comprising:
a display panel;
the display controller as defined in claim 1; and
a display driver which drives the display panel based on image data supplied from the display controller.

10. The electronic instrument as defined in claim 9, further comprising:
a host which performs output and input of the image data to and from the display controller.

11. An image data supply method of supplying image data to a display driver which drives a display panel, the method comprising:
writing the image data after first rotation processing into an image memory, the first rotation processing causing a vertical direction of an image of the image data to be supplied to the display driver to rotate by a first rotation angle; and
performing compression processing of the image data after second rotation processing which causes a vertical direction of an image of the image data read from the image memory to rotate by a second rotation angle, and supplying the image data read from the image memory by a sequential access operation to the display driver without performing the second rotation processing for the image data stored in the image memory.

12. The image data supply method as defined in claim 11,
wherein the number of frames in which the processing of writing the image data for one frame into the image memory is performed within a unit time is smaller than the number of frames in which the processing of reading the image data for one frame from the image memory is performed within the unit time.

13. The image data supply method as defined in claim 11,
wherein the processing of writing the image data into the image memory is given priority over the processing of reading the image data from the image memory.

14. The image data supply method as defined in claim 11,
wherein, when causing the vertical direction of an image of the image data before the first rotation processing to rotate by a rotation angle Ca with respect to a predetermined orientation in a predetermined rotation direction and causing the vertical direction of an image of the image data supplied to the display driver to rotate by a rotation angle La with respect to a predetermined orientation in a predetermined rotation direction, the first rotation angle is (La−Ca)°.

15. The image data supply method as defined in claim 11,
wherein, when the first rotation angle is Wa° (0≦Wa<360), the second rotation angle is (360−Wa)°.
